(19) United States
(12) Patent Application Publication
(10) Pub. No.: US 2006/0142079 A1
(43) Pub. Date: Jun. 29, 2006

(54) Universal progressive game pool

(75) Inventors: Clyde Ikehara, Reno, NV (US); Mark Bansemer, Reno, NV (US); Aaron Tucker, Reno, NV (US); Greg Anders, Reno, NV (US); Chris Lundy, Reno, NV (US); Garrett Olson, Reno, NV (US); Bryan Wolf, Reno, NV (US)

Correspondence Address: BEYER WEAVER & THOMAS LLP, P.O. BOX 70250, OAKLAND, CA, 94612-0250, US

(73) Assignee: IGT

(21) Appl. No.: 11/026,532

(22) Filed: Dec. 29, 2004

(51) Int. Cl. G06F 17/00; G06F 19/00

(52) U.S. Cl. 463/27

(57) ABSTRACT

The present invention provides systems and methods that allow gaming machines to participate in a progressive pool and offer a progressive award regardless of the game installed on the gaming machine. The present invention also permits gaming machine participation in a progressive pool regardless of wager amount. This permits larger progressive awards and awards that grow faster since more games and gaming machines may participate in building a progressive pool award. It also opens the attraction of a large progressive pool award to more games, gaming machines and gaming establishments.

### FIELD OF THE INVENTION

This invention relates to progressive pools and progressive pool awards employed in a gaming machine network.

### BACKGROUND OF THE INVENTION

Gaming machines are becoming increasingly sophisticated. Gambling machines that include a computer processor, LCD display and related computer peripheral devices are now the norm in place of older mechanically driven reel displays. Many casinos employ networks of electronically linked gaming machines. Each gaming machine may offer a different game stored as software in memory included with the gaming machine.

Multiple gaming machines may provide the same game. Some gaming systems operate a pool for a specific game. The pool refers to a finite size collection of predetermined game outcomes for the game. One outcome may refer to a loss while another refers to a win. As outcomes are used, they are eliminated from the pool and prevented from re-use.

Some centralized gaming systems offer a progressive jackpot for machines that run a specific game type (e.g., a jackpot for machines that run Video Poker). The progressive jackpot includes a large potential winning prize, e.g. millions of dollars. A gaming establishment advertises the jackpot near gaming machines that provide the specific game type to increase user appeal for these gaming machines.

A progressive jackpot is currently limited to gaming machines that offer one game type and one wager amount. If a casino runs ten or more different game types (e.g., NickelMania, Video Poker, Video BlackJack, Pachinko, Monopoly, etc.), it must run a different centralized system and jackpot of each game type. This significantly increases overhead. Some casinos offer over fifty games. In addition, the inability to combine progressive jackpots across different games reduces the number of participating gaming machines, jackpot size and jackpot growth rate for any one game. This lessens player appeal and opposes intent of the progressive jackpot in offering an alluring grand prize that increases player participation.

From the foregoing, it should be apparent the ability to provide a progressive jackpot across different games and wagers would be desirable.

### SUMMARY OF THE INVENTION

The present invention provides systems and methods that allow gaming machines to participate in a progressive pool and offer a progressive award regardless of the game installed on the gaming machine. The present invention also permits gaming machine participation in a progressive pool regardless of wager amount. This permits larger progressive awards and awards that grow faster since more games and gaming machines may participate in building a progressive pool award. It also opens the attraction of a large progressive pool award to more games, gaming machines and gaming establishments.

In some embodiments, gaming machines do not need to be modified to participate in a common progressive jackpot. This allows gaming machines, running any particular game, to advertise and grant a progressive award with little overhead to the gaming machine operator.

In one aspect, the present invention relates to a gaming system that provides a progressive pool to gaming machines. The gaming system comprises a first gaming machine that permits play of a first game type. The gaming system also comprises a second gaming machine that permits play of a second game type that is different from the first game type. The gaming system further comprises a progressive pool administrator. The administrator manages a progressive pool award that is winnable at the first gaming machine and the second gaming machine. The administrator also receives a progressive contribution generated at the first gaming machine and adds at least a portion of the progressive contribution to the progressive pool award. The administrator also receives a progressive contribution generated at the second gaming machine and adds at least a portion of the second progressive contribution to the progressive pool award.

In another aspect, the present invention relates to a gaming system that provides a progressive pool to gaming machines. The gaming system comprises a progressive pool administrator that a) creates a progressive pool that includes a set of outcomes for a progressive award and b) distributes the outcomes. The gaming system also comprises a progressive pool manager that receives a subset of outcomes from the progressive pool administrator. The progressive pool manager sends a first outcome of the progressive pool to a first gaming machine that permits play of a first game type. The progressive pool manager also sends a second outcome of the progressive pool to a second gaming machine that permits play of a second game type that is different from the first game type.

In yet another aspect, the present invention relates to a gaming machine that participates in a progressive pool. The gaming machine comprises an external cabinet that defines an interior region of the gaming machine. The external cabinet is adapted to house a plurality of gaming machine components within or about the interior region. The gaming machine also comprises a display device adapted to display game play information. The gaming machine further comprises a scanner configured to receive credit from a player that is used as a wager to initiate a game on the gaming machine. The gaming machine additionally comprises a processing system configured to output an outcome of the progressive pool to the player. Participation in the progressive pool by the gaming machine is independent of a game type played on the gaming machine. The gaming machine also comprises a network interface that allows the gaming machine to receive the outcome.

In yet another aspect, the present invention relates to a game pool manager that provides progressive pool outcomes for a progressive award to multiple gaming machines. The game pool manager receives a set of outcomes for a progressive pool. The game pool manager comprises a processing system that selects a first outcome of the progressive pool from the set of progressive pool outcomes for distribution to a first gaming machine that permits play of a first game type. The processing system also selects a second outcome of the progressive pool from the set of progressive pool outcomes for distribution to a second gaming machine that permits play of a second game type that is different from the first game type. The game pool manager further comprises a network interface that permits the game pool manager to send the first outcome to the first gaming machine and to send the second outcome to the second gaming machine.

In another aspect, the present invention relates to a method for building a progressive award. The method comprises adding at least a portion of a progressive contribution to a progressive award pool. The progressive contribution is generated at a first gaming machine that permits play of a first game type. The method also comprises adding at least a portion of a second progressive contribution to the progressive award pool. The second progressive contribution is generated at a second gaming machine that permits play of a second game type.

In yet another aspect, the present invention relates to a method for providing a progressive award to gaming machines that run different game types. The method comprises creating a progressive pool that includes a set of outcomes for the progressive award. The method also comprises distributing a first deck of outcomes included in the progressive pool to a first gaming machine that permits play of a first game type. The method further comprises distributing a second deck of outcomes included in the progressive pool to a second gaming machine that permits play of a second game type.

In still another aspect, the present invention relates to a method for awarding a progressive award to a gaming machine. The method comprises receiving a wager from a player at a gaming machine. The method also comprises determining a ratio between the wager and a reference wager for the progressive award. The method further comprises receiving a winning outcome for the progressive award. The method additionally comprises altering the progressive award using the ratio to create an altered progressive award. The method also comprises providing notice to the player of the winning outcome.

These and other features and advantages of the invention will be described in more detail below with reference to the associated figures.

### BRIEF DESCRIPTION OF THE DRAWINGS

FIG. 1A is a schematic diagram of a gaming machine system that offers a universal progressive pool across different games in accordance with the present invention.

FIG. 1B is a schematic diagram of a gaming machine network that offers a universal progressive pool across different games in accordance with another embodiment of the present invention.

FIG. 2A illustrates an exemplary gaming machine in perspective view according to one embodiment of the present invention.

FIG. 2B illustrates in perspective view the gaming machine of FIG. 2A having an opened main door.

FIG. 3 illustrates a process flow for seeding a universal progressive pool in accordance with one embodiment of the present invention.

FIG. 4 illustrates progressive contributions to a universal progressive pool from different games in accordance with one embodiment of the present invention.

FIG. 5 illustrates a process flow for building a universal progressive pool in accordance with one embodiment of the present invention.

FIG. 6 illustrates a process flow for building a universal progressive pool in accordance with another embodiment of the present invention.

FIG. 7 illustrates a process flow for awarding a progressive prize in accordance with one embodiment of the present invention.

FIG. 8 illustrates a process flow for awarding a progressive prize in accordance with another embodiment of the present invention.

FIG. 9 illustrates a process flow for managing a progressive prize in accordance with another embodiment of the present invention.

FIG. 10 illustrates a process flow for managing an award pool and a reserve pool in accordance with one embodiment of the present invention.

FIG. 11 shows an illustrative universal progressive pool in accordance with a specific embodiment of the present invention.

FIG. 12 illustrates an exemplary processing system in accordance with one embodiment of the present invention.

### DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

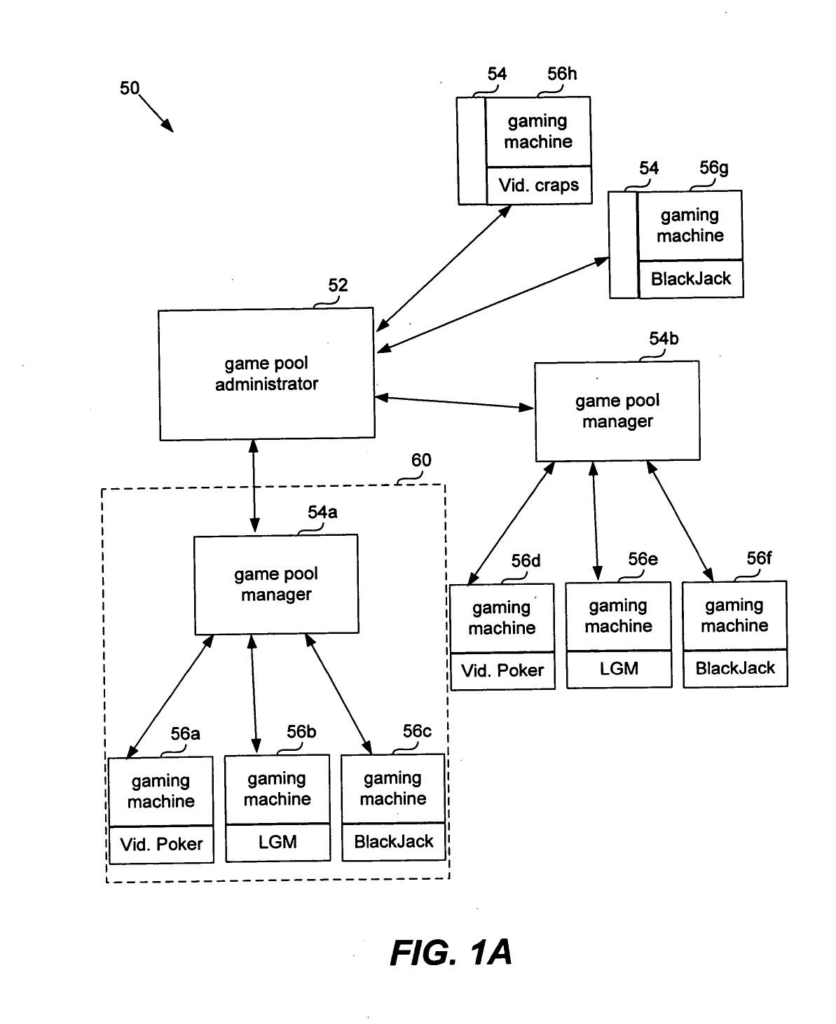

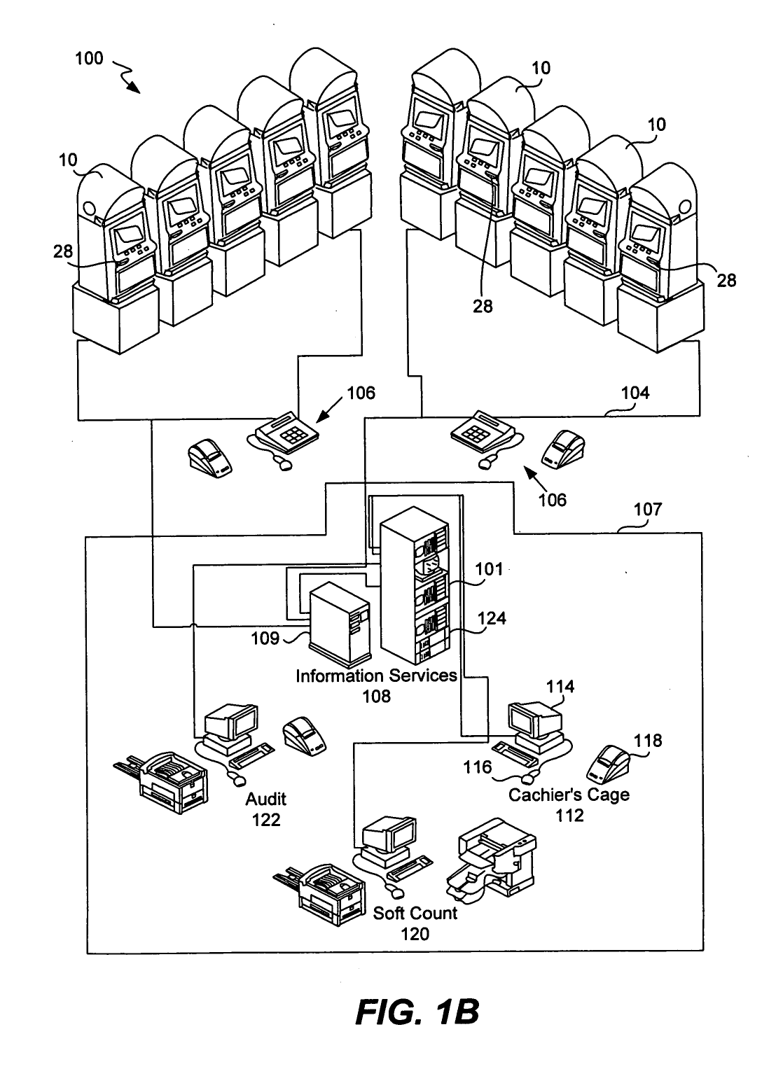

FIG. 1A illustrates a simplified gaming system 50 in accordance with one embodiment of the present invention. Gaming system 50 comprises game pool administrator 52, game pool managers 54, gaming machine network 100, and gaming machines 56.

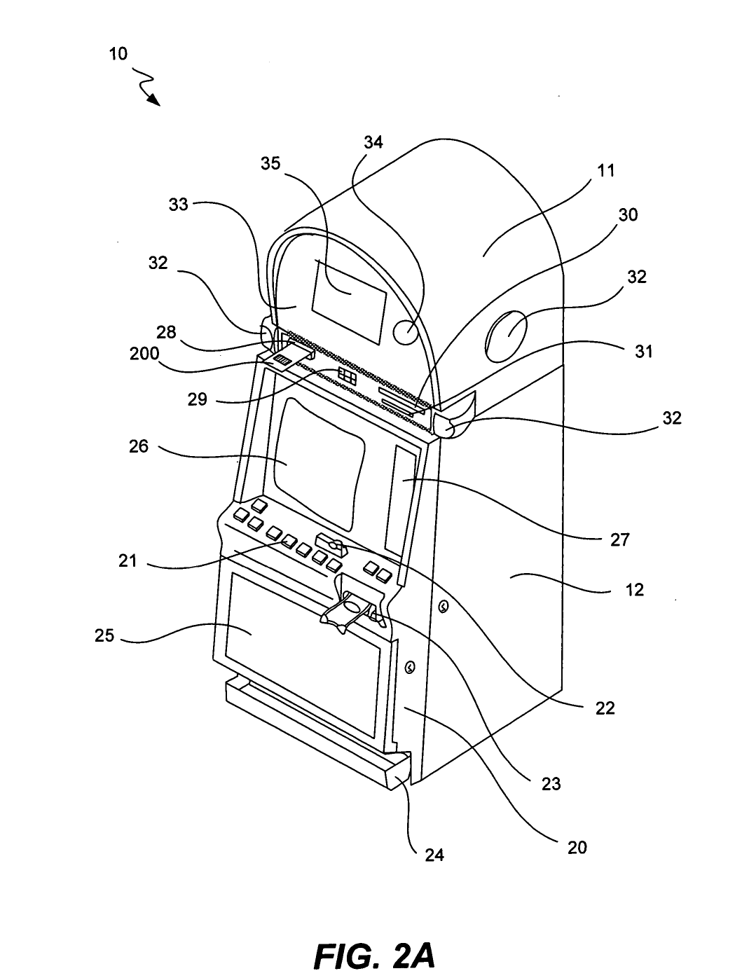

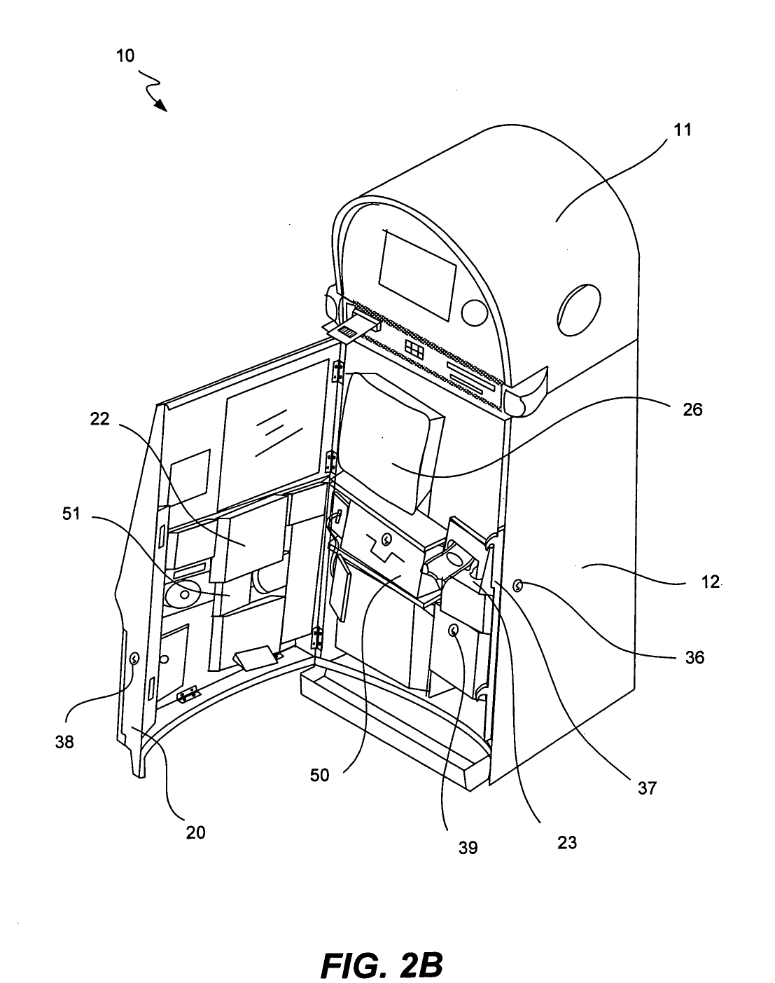

Gaming system 50 includes multiple gaming machines 56. Each gaming machine 56 presents a game and permits interaction with a player. A wide variety of gaming machines may be employed with the present invention. One suitable gaming machine 56 is described below with respect to FIGS. 2A and 2B. International Game Technology of Reno, Nev., is one exemplary gaming machine manufacturer that provides an array of gaming machine models suitable for use in system 50. Gaming machines from other gaming machine manufacturers may also be used with the present invention.

System 50 permits a gaming machine 56 to participate in a progressive pool and offer a progressive award for the progressive pool—regardless of the game run on the gaming machine. The terms ‘game’ and ‘game type’ are used interchangeably herein and refer to a set of rules that specify interaction between a player and the gaming machine. Usually, the game has an entertaining theme and related title. The gaming industry offers hundreds of games that are suitable for use with the present invention. Exemplary games (or game types) include Video Pachinko, Little Green Men, Video Poker, MEGABucks, NickelMania, etc. The present invention is not limited to any game. Conversely, the invention permits games and gaming machines that could not previously participate in a progressive pool to now contribute in building a progressive award and offer the progressive award. This also creates a progressive pool that includes participation from gaming machines running different games.

As shown, gaming machines 56a-c communicate with game pool manager 54a in a gaming machine network 100. For example, gaming machine network 100 (FIG. 1B) may be included in a casino, restaurant or other establishment that provides gaming services. Game pool manager 54b communicates with gaming machines 56d-f. Gaming machines 56d-f may represent separate gaming machines distributed across a geographic area, such as a city or state, that communicate with manager 54b using a communications link. Network 58 includes a collection of gaming machines 56g-h with no centralized controller. Gaming machines 56g-h communicate directly with game pool administrator 52. Gaming machines 56g-h may be included in a convenience store, for example.

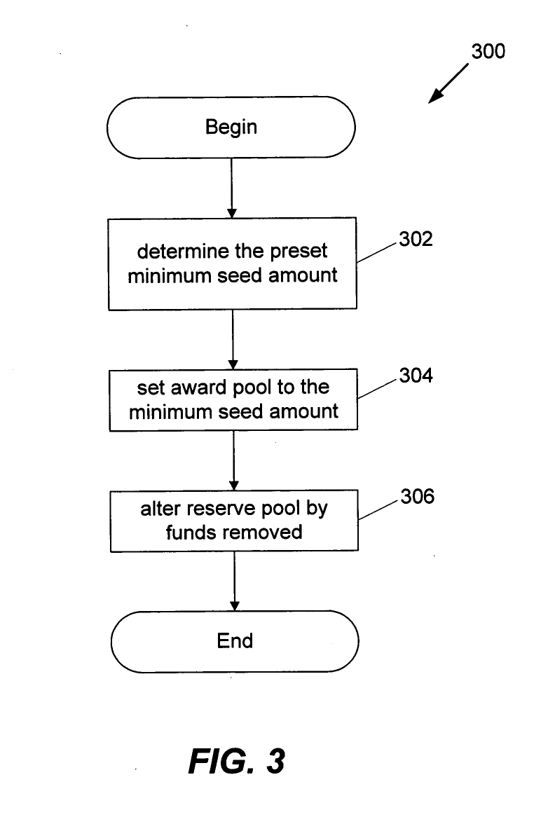

Game pool administrator 52 creates one or more game pools. A pool refers to a collection of predetermined game outcomes. Typically, the pool comprises a fixed number of outcomes. Each outcome may be stored as a data structure or record in a table, for example. FIG. 3 describes an exemplary game pool 200 in greater detail.

In one embodiment, game pool administrator 52 randomizes the order of records or outcomes in a game pool when creating a pool. This permits records to be sequentially selected from the pool—or portions thereof—without compromising randomness of outcome selection. This also permits portions of a large pool (or subsets of outcomes in the entire set of outcomes) to be distributed without compromising randomness of the distribution. Gaming machines or pool managers receiving the subsets may then sequentially select outcomes and maintain randomness. In another embodiment, outcomes in the pool are listed and randomly selected from the list by the pool administrator 52 upon distribution. Alternatively, listed outcomes are distributed in blocks and the receiving party (e.g., gaming machine 56 or manager 54) randomly selects from outcomes it has received.

The number and type of game pools created by administrator 52 may vary. Administrator 52 may create a game pool that includes outcomes for a specific game. Administrator 52 may also create and distribute a ‘micro’ progressive pool that includes outcomes for a progressive pool corresponding a specific game. For example, a Video Poker micro progressive pool may be generated and run for the Video Poker game. In this case, gaming machines 56 that run Video Poker may offer this micro progressive pool. Meanwhile, the Video Poker micro progressive pool receives contributions from (and grows from) gaming machines 56 that run Video Poker and participate in the Video Poker micro progressive pool.

Game pool administrator 52 also creates a ‘universal’ progressive pool. As the term is used herein, a universal progressive pool refers to a progressive pool that allows participation to gaming machines regardless of game type. In many instances, a universal progressive pool includes participation by gaming machines that run different game types. The universal progressive pool includes all possible outcomes for a progressive award or awards associated with the universal pool. In one embodiment, outcomes for a progressive pool are not related to outcomes for a specific game.

The present invention may offer any alluring award as a prize for a universal progressive pool. One common award is a progressive jackpot that awards a large sum of money to one or more winners and grows according to player activity on participating gaming machines 56. Generally, player appeal increases with jackpot size. Offering a universal jackpot across multiple games (and a larger number of gaming machines) allows the jackpot size to increase to larger sizes, and to grow faster after ajackpot has been won. This maintains a high level of interest in the universal progressive pool at all times. The outcomes may vary with the awards. In a specific embodiment, individual outcomes for a universal progressive pool contain a win/lose outcome related to one or more cash jackpots. Other awards are contemplated. For example, awards may include cars, vacations, real estate, and other accumulating or non- accumulating awards that increase player appeal to play on a gaming machine. If the universal progressive pool includes multiple awards, e.g., cash and cars, then the set of outcomes is varied to match.

Universal progressive pools may be flexibly created and implemented. For example, a universal progressive pool may be created and implemented for all games run in a single casino. The casino may then influence a payback scheme for all games and gaming machines 56 it operates. Alternatively, a universal progressive pool may be generated and implemented for all games provided by a particular gaming machine manufacturer. A universal progressive pool may also be collectively applied to all gaming machines within a geographic region, such as a city or state.

The present invention permits all gaming machines 56 in system 50 to offer a progressive award associated with the universal progressive pool—regardless of what game is stored on and provided by a particular gaming machine. In other words, gaming machines that run different games may all participate in the universal progressive pool. In this case, the universal progressive pool receives contributions from (and grows from) all gaming machines 56 in system 50 that offer the universal progressive pool award(s). This enables a greater universal progressive pool awards for each gaming machine 56 than would be available if each machine only offered a micro progressive pool corresponding to a specific game played on the machine (and a subset of gaming machines 56 within system 50). The universal progressive pool also accumulates and grows at a faster pace based on cumulative contributions from an increased number of participating gaming machines 56.

In one embodiment a universal progressive pool is created and implemented for a subset of game types within system 50. For example, a universal progressive pool may be set up for only three games within system 50, e.g., Little Green Men, MEGABucks, and NickelMania. In this case, only gaming machines 56 that run Little Green Men, MEGABucks, and NickelMania permit a player to win the universal progressive award and contribute to building the award. In addition, the universal progressive award receives contributions and grows only using contributions from gaming machines 56 that the selected game types.

In one embodiment, a gaming machine 56 selects outcomes for a game and progressive pool. For example, gaming machines 56g-h within network 58 include their own game pool manager 54 that receives outcomes for a micro or universal progressive pool and selects individual outcomes. In another embodiment, a gaming machine relies on a game pool manager 54 disposed outside the gaming machine 56 to select outcomes for a game and progressive pool. For example, game pool manager 54 may be included in a cluster controller.

In either case, after a predetermined trigger event, such as a user wagering at a gaming machine 56, game pool manager 54 (either at the gaming machine 56 or at a disparate manager 54) draws one or more outcomes. If game pool manager 54 is included in a separate device than a gaming machine 56, then the system or device including manager 54 sends the outcome to the gaming machine, e.g., via a communication link such as a dial up connection. The gaming machine 56 indicates (illustrates using video, informs via audio, etc.) the drawn outcome or outcomes to a player. The game pool manager 54 also prevents the selected outcomes from being provided to any player again until all outcomes in the pool have been expended.

This outcome selection may occur for a game played on the gaming machine, a micro progressive pool, and/or a universal progressive pool. Game pool manager 54 may thus be configured to multiply draw one or more outcomes from a game pool (e.g., Video Poker), one or more outcomes from a micro progressive pool and/or one or more outcomes from a universal progressive pool and provide the outcome(s) to a gaming machine.

Each game pool manager 54 requests one or more decks from game pool administrator 52. In addition, each gaming machine 56 in network 58 that includes a game pool manager 54 requests one or more decks from game pool administrator 52. The request may employ any communication link. For example, manager 54 and administrator 52 may communicate via a dial-up, dial-up/callback, wireless, or over a live dedicated communications link.

When a game pool manager 54 or gaming machine 56 requests a deck from administrator 52, administrator 52 may respond by providing: a) one or more game specific decks, b) one or more micro progressive pool decks, and/or c) one or more universal progressive pool decks. In one embodiment, the progressive pool deck is substantially same size as a deck provided for a game run on the gaming machine.

To facilitate service for multiple game pool managers 54, game pool administrator 52 may distribute a portion of each progressive pool. As the term is used herein, a deck refers to a set of outcomes that form a subset of outcomes for a set of outcomes in a game pool. For example, a game pool of 1 million records for a universal progressive pool may be divided into a hundred decks of ten thousand records each. Each deck may be separately distributed to a different game pool manager 54. The present invention contemplates dividing the game pool into any number of decks. For system 50, game pool administrator 52 distributes one or more decks to game pool managers 54 and gaming machines 56 in network of 58. Since the order of records in a pool has been randomized, distribution of decks may be done in a sequential manner, although the present invention is not limited to such sequential distribution. In one embodiment, game pool administrator 52 creates multiple decks for a given game and denomination, multiple decks for each micro progressive pool, and multiple decks for a universal progressive pool. Administrator 52 then distributes one or more decks to each manager 54 based on a request from each manager 54.

In one embodiment, each game pool manager 54 requests and maintains multiple decks for a game or progressive jackpot. More specifically, a pool manager 54 may be configured to receive and manage multiple decks for a game, multiple decks for a micro progressive pool, and multiple decks for a universal progressive pool. In a specific embodiment, records are drawn from multiple decks intermittently before any one deck is fully expended. For example, if four decks are stored in manager 54 for a universal progressive pool, outcomes from each universal progressive pool deck may be selected before any one of the four decks are fully expended. This avoids any delays in servicing gaming machines 56 when one pool has been expended. Further description of multiple game pool systems is provided in commonly owned pending patent application Ser. No. 10/261,744. The entire disclosure of this document is incorporated by reference in its entirety herein for all purposes.

Game pool managers 54a and 54b may responsively distribute game outcomes to gaming machines 56. When a player at a gaming machine 56 wagers and begins play, gaming machine 56 sends a message conveying the need for a game outcome. Managers 54a and 54b respond by selecting an outcome from a deck assigned to that game and relays the outcome (or a random number generator seed associated with the outcome) to the gaming machine 56. If there is a micro progressive pool associated with the game on the gaming machine 56, game pool manager 54 also selects an outcome from a micro progressive pool deck associated with the game. If there are one or more universal progressive pools associated with the game and gaming machine 56, game pool manager 54 also selects an outcome for the universal progressive pool deck. This may occur regardless if the gaming machine was originally configured for such a universal progressive pool.

Manager 54 may examines the selected universal progressive pool outcome or outcomes to detect for a winner. For each winner, manager 54 determines the amount of the progressive win and informs gaming machine 56 of the win and the win amount. If there are multiple progressive pool wins, manager 54 may relay each win individually as multiple wins or collectively as one large win.

While gaming system 50 only illustrates two game pool managers 54 and eight gaming machines 56, it is understood that gaming system 50 may comprise any number of game pool managers 54 and gaming machines 56. A single casino, for example, may comprise anywhere from one to fifty game pool managers 54 and one to 20 gaming machines per game pool manager. Some casinos include several thousand gaming machines 56. The casino may also offer a wide variety and number of game types. By contrast, a gas station may only include one or two gaming machines and one or two game types. A restaurant may comprise a single gaming game pool manager 54 and 10 gaming machines that each offer a different game. Any of these gaming establishments may participate in a universal progressive pool the present invention.

In one embodiment, gaming machines 56d-f are blind to any progressive pools that may be awarded by gaming machines 56d-f. In this case, software run on the gaming machine is not programmed to interface directly with game pool administrator 52 for the purposes of implementing a universal progressive pool. In this case, game pool manager 54b communicates with game pool administrator 52 and distributes individual outcomes to gaming machines 56d-f. This advantageously permits universal progressive pools of the present invention to be offered on gaming machines 56 already implemented in a gaming establishment without any alterations to the existing gaming machines. For example, a cluster controller for a set of gaming machines may be reconfigured to implement a universal progressive pool of the present invention while a gaming machine that communicates with the cluster controller requires no alteration.

System 50 also permits accumulation of universal progressive awards in real time. By knowing the denomination of each game and gaming machine in system 50, game pool administrator 52 may also compute an amount that is continually contributed to one or more progressive awards. In one embodiment, each gaming machine 56 controls progressive contributions added to a progressive jackpot. In another embodiment, one or more game pool managers 54 control progressive contributions added to a universal progressive award from each gaming machine 56 that each manager 54 communicates with. Either system permits greater granularity in progressive contributions and permits a more gradual progressive award growth.

As will be described below, a winning outcome may earn less than the full progressive jackpot. In one embodiment, the proportion of the progressive jackpot awarded to a player for a win at a gaming machine depends on how play at the game costs. In some cases, a ratio of the wager used to play to a maximum bet permitted for the universal progressive pool is used to alter the progressive jackpot award. For example, if the progressive pool permits a maximum bet of five dollars and a gaming machine only permits a maximum bet of one dollar, then the progressive pool jackpot is reduced by a fraction of 1/5. This permits gaming machines having different fixed wagered denominations to participate in a common universal progressive pool despite the fact that gaming machines in the system require different betting amounts for play.

The progressive jackpot may also be altered based on a wager selected by a person. For example, if the above mentioned gaming machine permits a maximum bet of one dollar and allows for incremental bets of $0.25, and a person wagers $0.25, the progressive pool jackpot is further reduced by a fraction of ¼. In one embodiment, the two fractional ratios of the progressive pool jackpot are combined. Thus, for the previous two examples, a $0.25 wager at a gaming machine that only permits an upper wager of ($1) ⅕ earns 1/20 the progressive jackpot when the maximum progressive pool wager is $5 (the ration can also be determined directly as wager/maximum for pool). Other fractional combinations are possible and should be apparent. Alternatively in this case, a $5 wager receives the full progressive award for a winning outcome of a universal progressive pool with a maximum bet is $5. In this manner, a universal progressive jackpot award may be prorated to a specific wager at a particular gaming machine 56.

After a win, the progressive jackpot is altered according to the size of the progressive jackpot award provided to a player. If the progressive jackpot award to the person constitutes the entire progressive jackpot (e.g., they bet the maximum allowed for the pool and received the full progressive jackpot), then the progressive jackpot is reset to a seed value. If the progressive jackpot award to the person is less than the full progressive jackpot amount, then reseeding the progressive jackpot from a reserve pool may be prorated according to the player's wager.

FIG. 1B is a schematic diagram of a gaming machine network 100 that offers a universal progressive pool across different games and gaming machines in accordance with another embodiment of the present invention.

Network 100 includes a set of gaming machines 10. Each gaming machine 10 may provide a different game and may participate in a universal progressive pool. For example, ten gaming machines 10 are shown that each may implement a different game. Alternatively, gaming machines 10 may offer four or five different games where the most popular game is offered by multiple machines. Each gaming machine 10 may also permit a different wager or incremental wagers. The present invention provides a universal progressive pool that may be implemented on each gaming machine 10.

In a specific embodiment, each gaming machine 10 that participates in the universal progressive pool displays a maximum winnable award for the pool. For example, a display including an array of light-emitting diodes may be disposed above one or more gaming machines 10 to vividly broadcast the jackpot amount to people near the gaming machines. In embodiments where the progressive pool jackpot includes a monetary award that grows over time, the display may continuously reflect increasing amounts of the pool.

One or more gaming machines 10 may be associated with a host that comprises a processing system configured to operate as a progressive pool manager for the gaming machines 10. In this case, the host is configured to a) communicate with a the game pool administrator, b) request and retrieve game pools or decks for one more specific games, a micro progressive pool and/or a universal progressive pool, and c) distribute outcomes from each pool to one or more gaming machines 10. As the term is used herein, a host refers to any computer a processing system that transmits information with the gaming machine 10 across a communication link 104. The host may comprise a single computer or a group of computers associated with one another on a network. System 100 may include several entities that operate as a host: information services 108, Clerk Validation Terminal 106, a computer at cashier's cage 112, a computer at audit station 122 and/or a computer at soft count station 120.

In one embodiment, numerous machines 10 connect to a single cluster controller or a Clerk Validation Terminal (CVT) 106. Some CVTs 106 may accommodate up to 64 machines. Each gaming machine 10 may receive cash from a player or a credit device that conveys some form of value. A gaming machine 10 that communicates with CVT 106 will accept credit devices from other gaming machines 10 connected to the same CVT 106.

As there may be many groups of gaming machines 10 in a large casino or other establishment, multiple CVTs 106 may be implemented. The CVTs 106 are connected to a local area network (LAN) 107 which includes a number of computers or workstations as well as terminals, disk drives with fixed and/or removable media, printers and other peripherals. The computers on the LAN 107 may provide the casino with various functions such as processing jackpots and fills, steps related to universal progressive pool information management and methods described below, and generating accounting reports and security reports, etc. Other components connected to LAN 107 may include multiplexers, modems, and phone lines to an external system or network.

Some casinos connect multiple local area networks to wide area networks spanning multiple casinos. Such wide area networks allow groups of slot machines at various casinos to be connected to one another to permit universal progressive pools of the present invention to span multiple casinos. This allows jackpots from multiple machines in many locations (without restriction to game type or wager denomination) to grow as one large jackpot. In one embodiment, the wide area network spans a geographic region such as the city or state and permits universal progressive pool participation from gaming machines anywhere in the city or state.

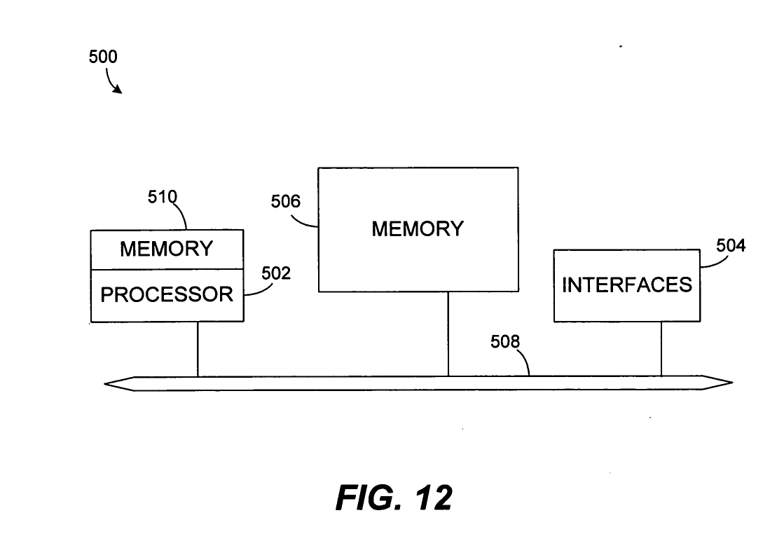

LAN 107 also includes information services 108. Each gaming machine 10 and CVT 106 communicates with information services 108 via LAN 107. Information services 108 includes a processing system 101 that is configured to a) request universal progressive game pools or decks from a game pool administrator and/or b) distribute game pool outcomes for the universal progressive pool the gaming machines 10. Processing system 101 may comprise any suitable combination of hardware and/or software for carrying out these and other gaming machine related functions. One suitable processing system 101 will be described below with respect to FIG. 12. Some form of memory is typically included within processing system 101. The memory stores information regarding universal progressive game pools, such as instructions stored in memory as computer readable media and programs for implementing steps and instructions as described below. In a specific embodiment, processing system 1 01 includes memory that stores a) one or more game pools for specific games run within network 100, b) one or more game pools for a micro progressive pool offered by a particular game in network 100, and c) one or more game pools for a universal progressive pool offered by any participating gaming machine.

Information services 108 also includes a front end controller 109 that acts as a general controller for network 100. Controller 109 may continuously poll the various CVTs 106 and request information pertaining to gaming transactions in the network 100. The CVTs 106, in turn, continuously poll machines 10. For example, if person has placed a wager at a gaming machine 10, that machine will communicate an wager event to its CVT 106 in response to the next CVT 106 poll. Then when the front end controller 109 polls the CVT 106, the CVT 106 communicates the wager event to the front end controller 109.

LAN 107 includes various additional stations. A cashier's station 112 is included for redemption of awards distributed within the network 100. Cashier's station 112 includes a computer 114 with a printer 118 and an optical scanner 116, such as a bar code scanner, for reading credit devices printed by a gaming machine 10. Network 100 may include as many cashier stations 112 as required to support a facility.

Additional stations may be included in the LAN 107. For example, the LAN 107 and may include a station in charge of security and a workstation in charge of surveillance. A soft count station 120 may also be included for daily verification of bills and tickets accepted gaming machines 10 in the network 100. An audit station 122 may also be included for accounting purposes. Any of the stations in the LAN 107 may include a processing system as described below. Each of the stations on LAN 107, including the front end controller 109, may be implemented on any of a variety of commercially available computer systems. Such machines include, but are not limited to, PC compatibles, DEC VAXs, and UNIX machines. In alternative embodiments, various network functions such as front end control are accomplished by distributed processing. In such cases, the network functions are performed on multiple nodes.

In the depicted example, information services 108 also includes a file server 124 which is the main processor in the network. A suitable file server machine is the Compaq 550 available from Compaq Computers. The file server communicates with all stations included on the LAN 107. The file server communicates with an external host, such as a computer configured to administer a universal progressive pool as operated by an external gaming services provider. For example, International Gaming Technologies of Reno, Nev., provides progressive pool services and may include a computer that communicates across communication links between Reno, Nev. and the location of the casino that includes network 100. The communication links may include any suitable data transfer system known to one of skill in the art. For example, computers for the casino and gaming services provider may be located on an external network and linked through a modem or another suitable Internet communication interface.

Network 100 electronically transfers universal progressive pool information between a central processing system 101 and each gaming machine 10. Such information may include digital representations of outcomes selected from a pool and winning instructions in digital form. For this purpose, network 100 includes one or communication links. A communication link may employ lines or cables 104, which may take various forms including coaxial wires, wireless connections or fiber optic cable, as one of skill in the art will appreciate. Wireless communication links may also be employed.

Although gaming system 100 includes a modular system suitable for use in a large gaming establishment such as a casino, it is understood that gaming systems of the present invention need not comprise such complexity. In some cases, gaming system 100 comprises a few gaming machines 10 where each gaming machine includes a processing system configured to a) participate in a universal progressive pool independent of a game run on the gaming machine and b) provide win/loss outcomes of the universal progressive pool to a player interfacing with the gaming machine. Systems 100 that include between about 1 and about 10 gaming machines are common in establishments such as grocery stores, gas stations and convenience stores for example.

Additional description of gaming machines 10 is described in further detail below. FIGS. 3-10 illustrate exemplary methods of implementing a universal progressive pool in accordance with various embodiments of the present invention.

FIG. 3 illustrates a process flow 300 for seeding a universal progressive pool in accordance with one embodiment of the present invention. Process flow 300 provides an exemplary answer to the question: how does one initiate a universal progressive pool? The present invention contemplates other ways to seed a universal progressive pool.

Process flow 300 begins by retrieving a preset minimum seed amount (302). The minimum seed amount refers to an initial award offered by a universal progressive pool in one of two conditions: a) when the universal progressive pool is first created, and b) after a player wins the entire universal progressive pool award or awards. In one embodiment, a gaming services provider implements the universal progressive pool and separates a portion of cash flow received from gaming machines that participate in the universal progressive pool for the purposes of building a reserve pool. The reserve pool stores the minimum seed amount. In the event that a person wins the entire universal progressive pool award, the reserve pool permits the gaming services provider to immediately re-seed the progressive award. This avoids any disruptions in player attraction to gaming machines that offer the universal progressive pool and its alluring large award.

If the universal progressive pool offers a monetary jackpot for example, then the minimum seed amount may represent an alluring initial jackpot. One million dollars may be suitable in many cases as a minimum seed amount. Other seeds less than and greater than one million dollars are also contemplated. The seed amount may also be determined according to economic considerations for a universal progressive pool. More specifically, the minimum seed amount may be determined using an expected amount of participation for the universal progressive pool based on a number of gaming machines that participate in the universal pool and an expected cash flow from all participating gaming machines. For example, if the universal progressive pool witnesses $100 million in cash flow every year, the minimum seed amount may be set to a percentage of the annual income, say 5%. As described above, an advantage of the present invention is that participation from an increased number of gaming machines allows larger jackpots. In addition, it also permits larger minimum seed amounts—and allows a universal progressive pool cash jackpot to immediately appeal to users without any delay in building the jackpot based on user activity. Alternatively, a casino operating its own progressive pool may set a minimum seed amount that it deems will induce player patronage.

Progressive awards may comprise awards other than money. A progressive award that offers real estate as a grand prize may correspond to the value of real estate awarded with a win. In this case, the winning real estate value may grow with progressive contributions from gaming machines that participate in the universal progressive pool. The minimum seed amount may be set to some predetermined real estate value. For example, a winning real estate award may be seeded and started at a value of $250,000. As contributions from gaming machines that participate in the universal progressive pool accumulate, the winning real estate value may grow to increased values, say to a million dollar home, or more. While the present invention will now primarily be discussed with respect to cash awards and jackpots for a universal progressive pool, it is understood that large awards other than cash may be employed by methods and systems described herein.

In one embodiment, the minimum seed amount is determined before implementation of a universal progressive pool. For example, the gaming services provider may be responsible for determining the minimum seed amount to process flow 300 calls upon the predetermined amount, e.g., as stored in memory.

Process flow 300 then proceeds by setting the universal progressive award pool to the minimum seed amount (304). At the least, this comprises a record keeping transfer that includes an electronic change in monetary allocation. In one embodiment, this also implies transferring actual funds from a reserve account (or other financial vehicle for storing money) that stores the minimum seed amount to an award account that maintains funds awarded to players that receive a winning outcome for the progressive pool.

The reserve pool, or any other mechanism used to store and/or maintain record of the minimum seed amount, is then altered by the amount provided to the progressive pool (306). As will be described below, the present invention may replenish funds removed from the reserve pool over time using a portion of progressive contributions from all gaming machines that participate in the universal progressive pool.

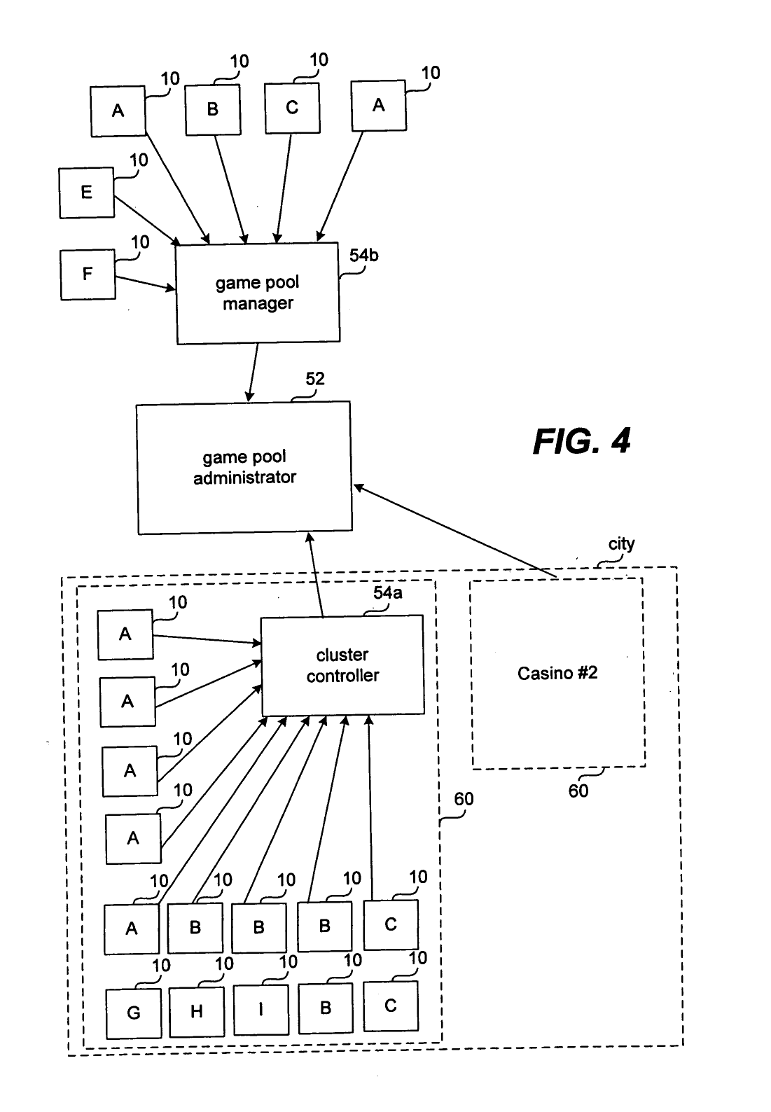

FIG. 4 illustrates progressive contributions to a universal progressive pool from different games in accordance with one embodiment of the present invention. The gaming machines 10 offers a number of games (or game types) A, B, C, D, E, F, G and H. Some games may participate in the universal progressive pool (A-F), others do not (G-I). Not all gaming machines offering a particular game need participate. Casino 60 for example operates games B and C that both do and do not participate.

Each gaming machine 10 receives a wager in the form of game credit from a player. In one embodiment, a portion of each wager goes to the universal progressive pool award. A message from each gaming machine signaling one or more wagers is transmitted from the gaming machine to the administrator 52. This may include direct communication or indirect communication via a universal progressive pool or cluster controller for example. Indirect communication through each manager 54 may also comprise time delays, buffering and other processing at each manager 54. Each gaming machine 10 may require or offer a different wager for game play, as will be described in further detail below.

In one embodiment, a portion of each wager made at a participating gaming machine is used to build a progressive award. In another embodiment, a gaming machine pays a regular fee for each participating gaming machine. Other progressive award accumulation schemes are permissible.

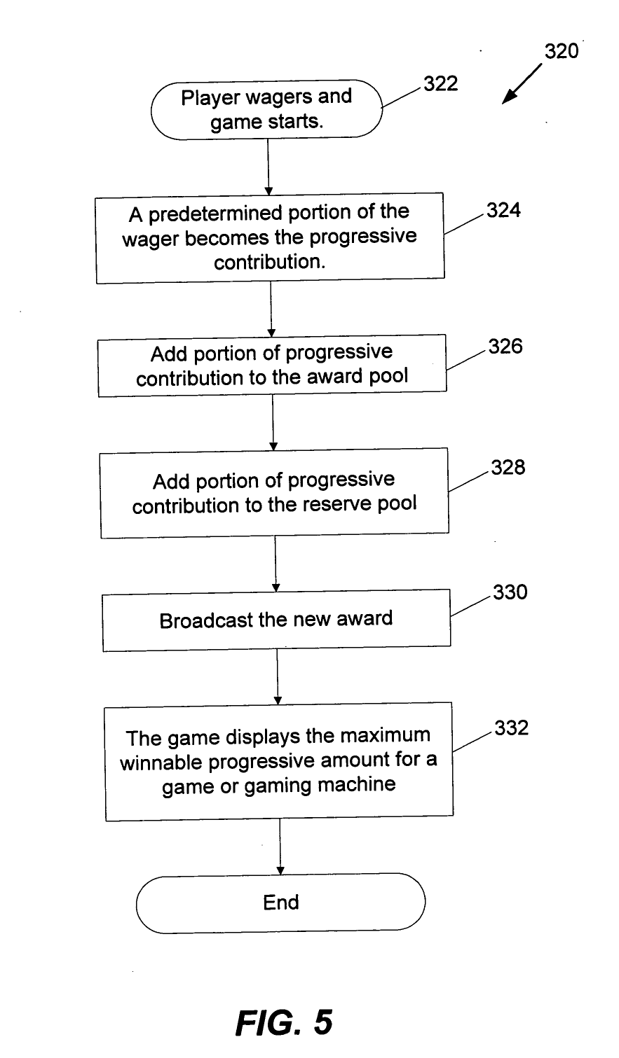

FIG. 5 illustrates a process flow 320 for building a universal progressive pool in accordance with a specific embodiment of the present invention. Process flow 320 varies universal progressive pool collections and awards based on a maximum wager available to a gaming or gaming machine.

While some steps for process flow 320 may occur at a gaming machine, it is understood that other steps may not occur at the gaming machine. For example, the gaming machine may communicate with a game pool manager such as manager 54 described above. In this case, steps of process flow 320 that involve interaction between the universal progressive pool and a player occur at the gaming machine, while steps that do not require interaction with the person may occur at a gaming machine and/or at a separate gaming system component, such as a manager 54 or cluster controller.

Process flow 320 begins by receiving a wager from a player at a gaming machine (322). The wager may comprise cash deposited into the gaming machine or receipt of a credit device, such as a plastic voucher or paper ticket honored by a casino or gaming establishment that runs the gaming machine. Different games and gaming machines provide varying wager options. For example, one gaming machine may require a nickel, dime or quarter bet. Another gaming machine may require a dollar, two-dollar, or five-dollar bet. The present invention permits gaming machine participation in a universal progressive pool and offers opportunity to win the pool jackpot (or a portion of the pool jackpot) regardless of the wager required for a game or gaming machine. In one embodiment described below, lesser wagers (those smaller than the maximum used to win the entire jackpot) only receive a portion of a winning jackpot.

After the player initiates gameplay, a predetermined portion of each wager is then contributed to the progressive pool (324). In this embodiment, each gaming machine that participates in a progressive pool contributes a portion of each collected wager to the pool. For example, a percentage of each wager may be contributed to the universal progressive award. In a specific embodiment, each game or gaming machine contributes the same amount to a universal progressive award for wager placed at the gaming machine. For example, each gaming machine may contribute two cents each time a person wagers at the gaming machine and receives an outcome from the universal progressive pool. If the contribution remains constant despite gaming machine and game, the percentage provided by each gaming machine may then vary. For example, a required wager of one dollar and contribution of two cents corresponds to a 2% progressive pool contribution from the game and gaming machine for each wager. A wager of $0.50 and contribution of two cents corresponds to a 4% progressive pool contribution from the game and gaming machine. A wager of $5 and contribution of two cents corresponds to a 0.4% progressive pool contribution. In this manner, the present invention permits progressive pool participation despite differences in wager amounts at different gaming machines, and distributes growth of the progressive jackpot among participating gaming machines in games substantially evenly. In another embodiment, contributions from games and gaming machines that participate in the progressive jackpot are not equal. In other words, one game or gaming machine may contribute more to the progressive jackpot than another.

As one of skill in the art will appreciate, the predetermined portion of each wager contributed to progressive pool may vary with pool design. Constant contributions may range from fractions of a penny to several dollars for each wager. For example, gaming machines that receive nickels to play a game are very popular. These gaming machines may also offer a universal progressive award—regardless of the specific game played on the gaming machine. While the amount contributed to the progressive pool from each wager may be less than a penny in this case, participation by hundreds or thousands of gaming machines across a wide area network (e.g., an entire state) permits a winning jackpot for this common pool to grow rather appreciably based on a high-volume player activity across a large number of games and machines.

Thus, a universal progressive pool in this case steadily increases by amounts according to each wager made on a large number of machines participating in the pool. As more people play gaming machines that offer the universal progressive pool, the universal progressive pool award further grows, which also increases allure to play the participating games. In some cases where thousands of gaming machines across a large geographic area participate in a universal progressive pool, incremental increases from thousands of machines may quickly increase the progressive award size.

Process flow 320 determines a percentage, p, of the progressive contribution that goes to the universal progressive award pool. The award pool refers to a) a vehicle such as a bank account that stores the universal progressive funds until they are fully or partially awarded to a winner, and/or b) a digital representation of a). As one of skill in the art will appreciate, progressive awards may frequently surpass 1 million dollars. In a specific embodiment, the gaming services provider is responsible for collecting moneys from the gaming machines for the universal progressive pool and managing the award pool. In this case, when a person receives a winning outcome for the universal progressive pool, the gaming services provider verifies the winning outcome and pays the person if valid. In one embodiment, p is established before implementation of the universal progressive pool. For example, 80% of all moneys collected from wagers in gaming machines may be added to the award pool to increase the size of a cash jackpot in real time. Thus, in the previous example where two cents is collected from each wager played on a gaming machine that participates in the universal progressive pool, 1.6 cents is added to the cash award. Process flow 320 then adds a percentage, p, of the progressive contribution from the gaming machines and wagers to the award pool (326).

Remaining moneys in the progressive contribution may be set aside for other purposes. In the embodiment shown with process flow 320, a portion of the progressive contribution goes to a reserve pool (328). The reserve pool refers to i) a vehicle such as a bank account that stores the reserve funds until they are fully or partially used to re-seed the award pool, and/or ii) a digital representation of i). As mentioned above, the reserve pool may be used to seed a jackpot in the event that someone wins the whole jackpot and empties all funds in the award pool. In a specific embodiment, the percentage of the progressive contribution given to the reserve pool is about (1-p). For example, 20% may be set aside for a reserve pool used to seed the jackpot. The present invention contemplates other ratios provided to the progressive award pool and the seed or reserve pool. In a specific embodiment, the gaming services provider responsible for administering the universal progressive pool and managing the award pool also manages the reserve pool. In some cases, the gaming services provider may deduct a small portion of the progressive contribution to remedy overhead and costs associated with managing and servicing the universal progressive pool, jackpots, award pool, and reserve pool.

The universal progressive pool award thus increases as a result of continuing contributions to the award pool from any games and gaming machines participating in the pool. Process flow 320 may then broadcast the new universal progressive pool award (330). In one embodiment, a universal progressive cash jackpot grows in real time and is broadcast in real time to displays that inform casino patrons of the growing jackpot.

The present invention permits different games and gaming machines that offer different wagers to participate in a common universal progressive pool. The present invention also permits partial awards to be granted for a winning outcome. In one embodiment, a gaming machine's maximum winnable amount for a universal progressive pool is based on how much is wagered at the gaming machine. In a specific embodiment, the maximum winnable amount is proportional to a ratio between the game or gaming machine's maximum wager to the progressive pool's maximum wager. In this case, the maximum winnable progressive cash award for a game equals the universal progressive award times the ratio between the game or gaming machine's wager to the universal progressive pool's maximum wager. For example, a $10 million universal progressive cash jackpot may only award a $2 million jackpot for a game or gaming machine where the maximum bet is one dollar while the maximum wager for the progressive pool is five dollars. The game or gaming machine may then display its maximum winnable progressive amount if this amount differs from the universal progressive pool jackpot (332).

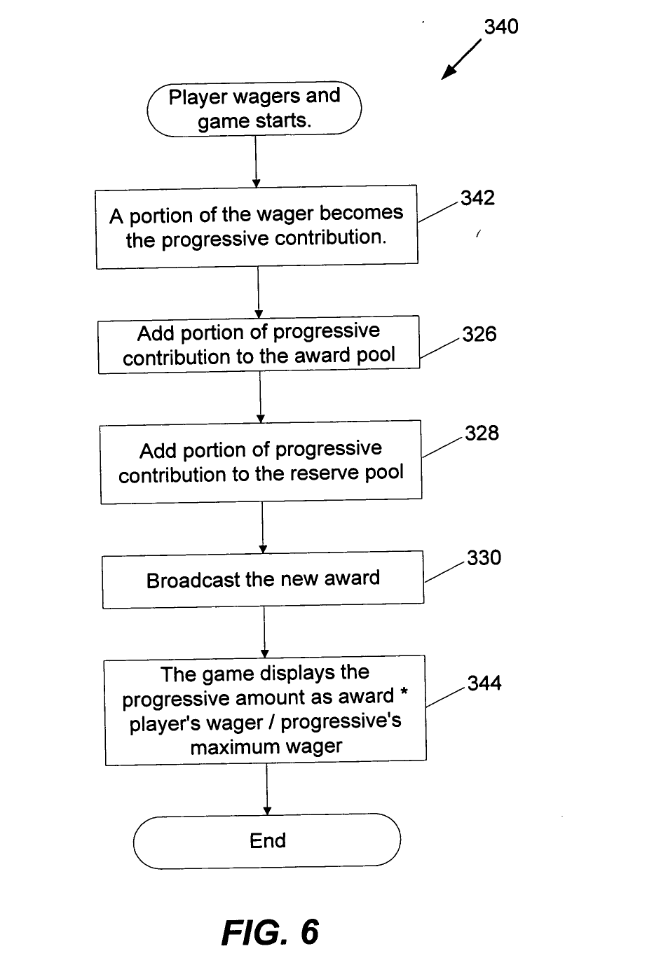

FIG. 6 illustrates a process flow 340 for building a universal progressive pool in accordance with another embodiment of the present invention. Process flow 340 varies universal progressive pool performance based on an amount wagered by a person at a gaming machine. Many gaming machines do not include a fixed wager to initiate play but permit a player to choose and input a wager from a range of wager amounts.

Process flow 340 begins when a player wagers on a game at a gaming machine (342). This may include a partial bet as permitted by the game and gaming machine. Many games and gaming machines allow a person to choose how much they want to wager. For example, a game may offer one-dollar betting increment options of from one dollar to five dollars. Alternatively, a game and gaming machine may offer nickel, dime and/or quarter betting increment options ranging from 5 cents to 5 dollars. Other betting increments, minimum bets and maximum bets are suitable for use with the present invention. Wager amounts and protocol may vary based on the game. For example, some games offer bonus rounds in which players may wager additional quantities in addition to any opening wagers made to initiate a game. In one embodiment, the progressive contribution from the gaming machine to the progressive pool is constant—despite the ability for differing awards. Thus, a nickel, dime and/or quarter may all contribute the same amount to the progressive pool.

After the player wagers and game starts, process flow 340 proceeds similarly to process flow 320: a predetermined portion of the wager is set aside for contribution to the universal progressive pool (324); a percentage or portion of the progressive contribution is then a set aside for increasing the award and placed in an award pool (326); another portion of the progressive contribution is set aside to build the reserve pool (328); and the increasing jackpot is broadcast (330) to casino patrons to increase allure and participation.

The universal progressive pool award then adapts to the incremental or partial wager made by the player to initiate play on the gaming machine. In this case, the present invention determines a second ratio, R2, that corresponds to a ratio of the player's wager to a maximum wager permitted in the universal progressive pool. For example, if the player wagered $0.50 on a machine that permitted betting increments of a quarter, and the maximum wager permitted in the universal progressive pool was $5, then the gaming machine or pool manager computes R2 at a ratio of 1/10. The universal progressive pool may then provide a partial award to the player for a winning outcome based on R2. For example, the $10 million universal progressive jackpot discussed above will only award a $1 million dollars in this illustrative example. The game or gaming machine may then display the winnable progressive amount (342).

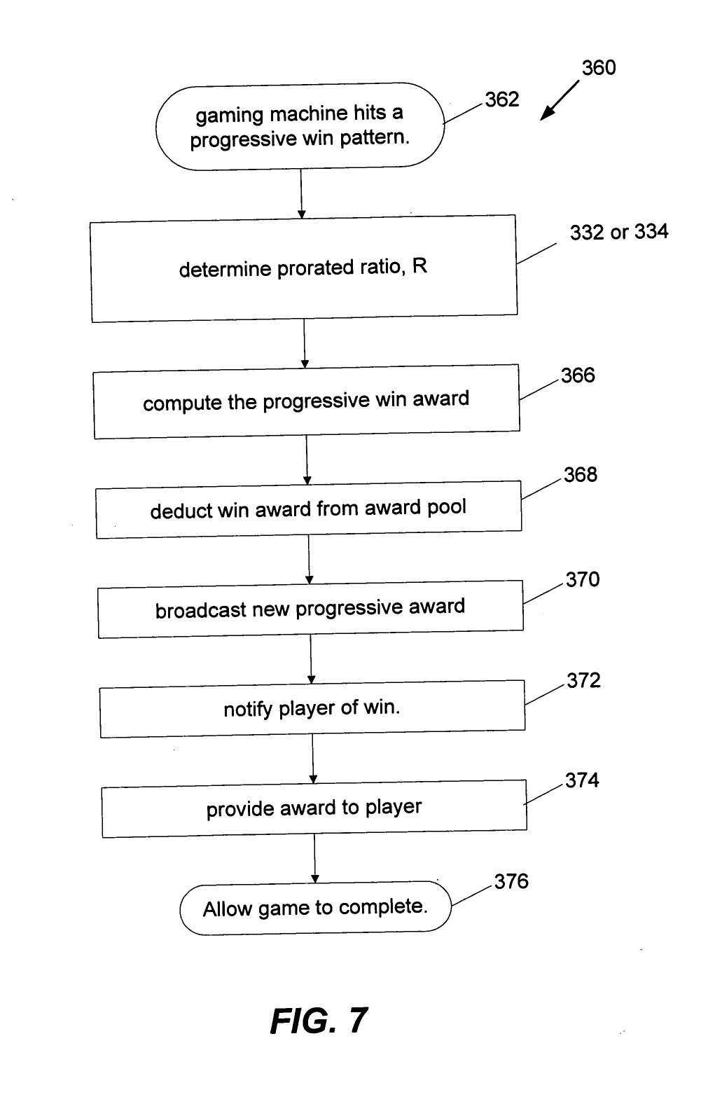

In one embodiment, an award for a universal progressive pool winning outcome is automatically awarded to the player. FIG. 7 illustrates a process flow 360 for awarding a progressive prize in accordance with one embodiment of the present invention.

Process flow 360 occurs in response to a player initiating a game at a gaming machine. In one embodiment, gaming machine receives a universal progressive outcome from an external game pool manager that distributes outcomes to one or more gaming machines. In another embodiment, the gaming machine itself acts as a pool manager and draws outcomes from a universal progressive game pool stored on the gaming machine. For process flow 360, the outcome drawn or received by the gaming machine is a winning outcome (362).

A prorated ratio is then determined to resolve how much of the universal progressive pool jackpot to award (332 or 344 as described above). The ratio is then used to determine the universal progressive pool win amount (366). For example, the maximum bet for the universal progressive pool may be five dollars and the player wagered five dollars. In this case, the person wins the entire jackpot. Alternatively, the person may have bet on a fixed one dollar betting machine and thus qualifies for only ⅕ of the jackpot. Other fractions of the jackpot may be awarded based on incremental bets.

The winning amount, A, is then deducted from the award pool (368) to create a new award pool amount or new jackpot. The new award pool amount may then be broadcast to maintain real-time reporting of the universal progressive pool jackpot (370).

The gaming machine then notifies the player of the universal progressive pool award win (372). This may include any combination of audio and video from the gaming machine. In addition, other nearby gaming machines in a network may participate in the notification signal magnitude of the event.

The person is then provided the universal progressive pool award (374). In one embodiment, the gaming machine notifies casino personnel who provide the award to the player. In another embodiment, the gaming machine prints out a paper ticket or voucher that conveys the value of the win and any information required for redemption of the win. The voucher may then be cashed at a cashier station or other terminal at a gaming establishment. Other techniques for conferring the award are contemplated. For example, the voucher may be presented to a gaming services provider that manages the universal progressive pool and redeems the voucher.

In one embodiment, the outcome for the universal progressive pool is independent of any game being played on the gaming machine. The gaming machine may provide a win or loss independent of the outcome for the universal progressive pool (376). The player is then informed of either outcome for the game in addition to the outcome for the universal progressive pool.

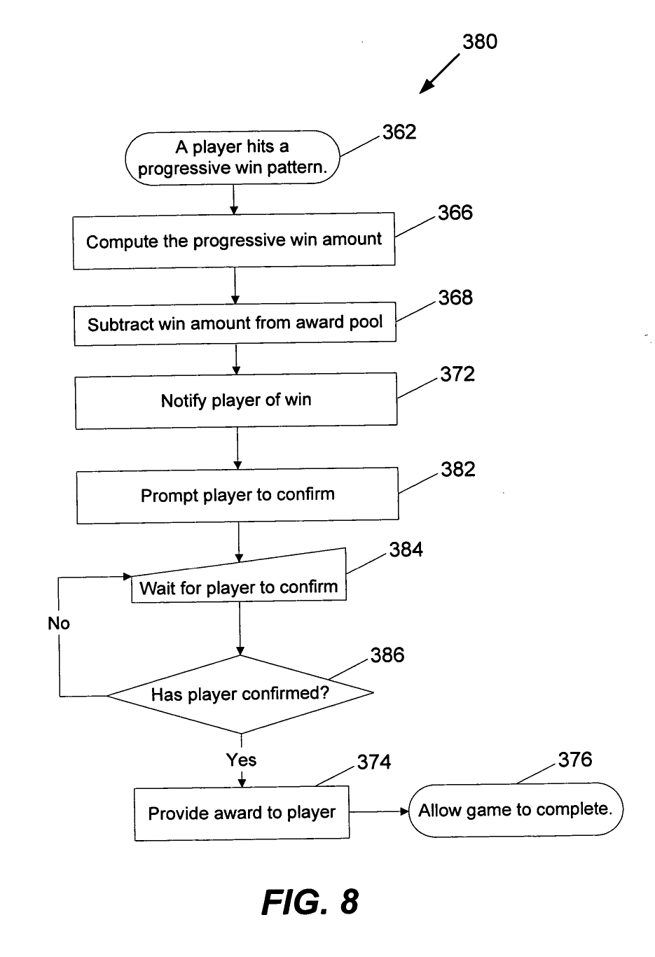

In another embodiment, an award for a universal progressive pool-winning outcome is not automatically awarded to the player and requires player confirmation. FIG. 8 illustrates a process flow 380 for awarding a progressive prize in accordance with another embodiment of the present invention.

Process flow 380 begins similarly to process flow 360 by receiving a winning outcome (362); computing the progressive win amount (366); and deducting the win amount from an award pool (368). The gaming machine then notifies the player of the progressive win (372).

In this embodiment, the gaming machine also prompts the player for confirmation (382). The prompt may comprise a visual message output on a video display included in the gaming machine or an audio message output on one or more speakers, for example.

Process flow 380 then waits for the person to confirm the win (384). This may comprise selecting a specific button indicated by the game for the gaming machine for confirmation, or selecting any button included in the gaming machine. Other techniques and forms of interaction for confirming the win with a gaming machine are contemplated.

Confirmation then waits for input from the player (386). More specifically, the gaming machine waits for confirmation if it has not received confirmation input from the player. If the gaming machine has received confirmation, it awards the win to the player (374). The gaming machine may also conclude any game being played on the gaming machine that permitted participation with the universal progressive pool (376).

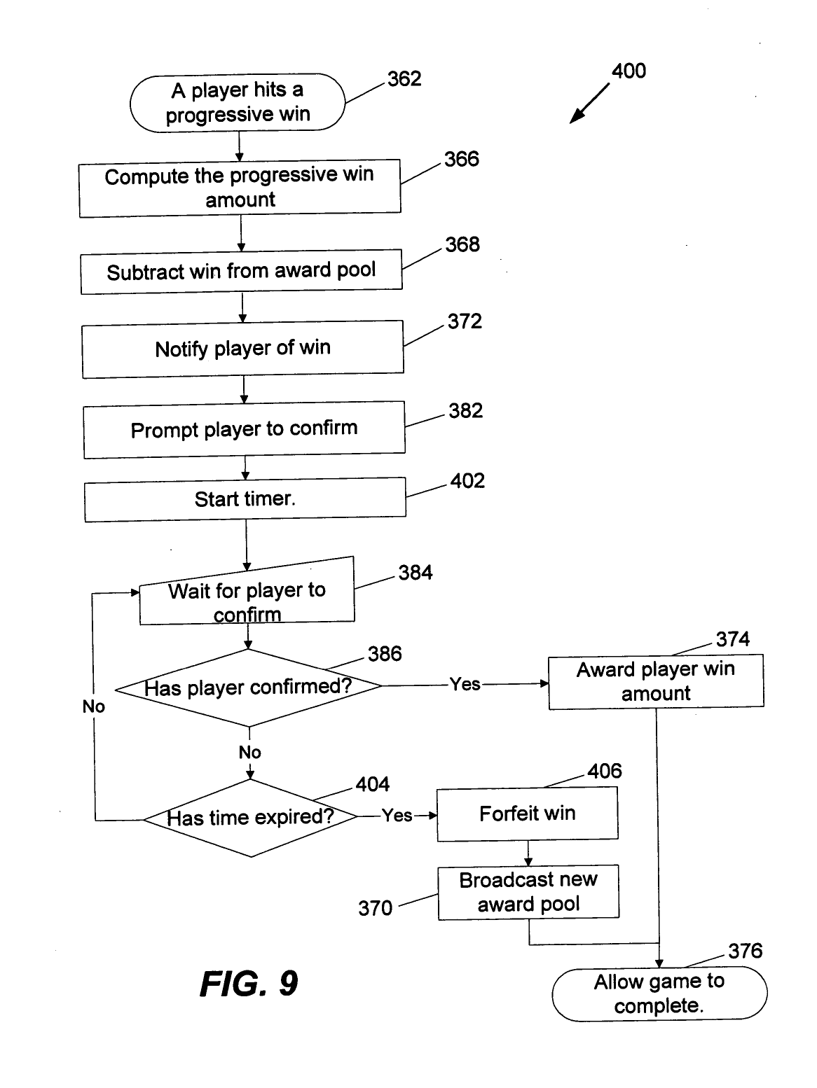

In another embodiment, the present invention returns unconfirmed wins back to a universal progressive award pool. More specifically, the present invention may allocate winning funds upon discovery of a winning outcome out of an award pool, wait for confirmation from a player, and if the player does not confirm, return the winning funds back to the award pool. FIG. 9 illustrates a process flow 400 for managing a progressive prize in accordance with another embodiment of the present invention.

Process flow 400 also begins similarly to process flow 380 by receiving a winning outcome (362); computing the progressive win amount (366); and deducting the win amount from an award pool (368). The gaming machine then notifies the player of the progressive win (372) and waits for confirmation from the player (382).

In one embodiment, the present invention applies conditions onto collection of a universal progressive pool award. One condition may be confirmation by the player. Another condition may include confirmation within a specific time. Another condition may include retrieving a printed-paper ticket from the gaming machine that indicates a win and redeeming the ticket at a cashier's stage. Other conditional requirements for redeeming a universal progressive pool award may be applied.

Process flow 400 starts a timer and sets at time of response for confirmation (402). In one embodiment, the timer starts when the gaming machine prompts the player for confirmation (382). In another embodiment, the timer starts when the gaming machine notifies the player of the win (372).

The gaming machine then waits for the player to confirm (384). If the player confirms (386), then the gaming machine provides the award or indication of the award to the player (374).

If the player does not confirm, process flow 400 then checks to determine if a predetermined confirmation time limit has expired (404). For example, the time limit may be 30 seconds. The time limit may range from seconds to several minutes. In a specific embodiment, the time limit ranges from 15 seconds to a minute.

Once the confirmation time has expired and the player has not confirmed the win with the gaming machine, the universal progressive pool award is forfeit and the award is returned back to the award pool. For example, jackpot money allocated for this particular winning outcome is returned back to the award pool (404). This permits the money to be made available to other universal progressive pool winners. The new universal progressive pool award amount is then broadcast for all gaming machine that participate in the universal progressive pool to (370).

In one embodiment, the game delays until the confirmation time limit has expired. In this case, the game waits and completes (376) after the award has been provided to the player or the confirmation time has expired. In another embodiment, the confirmation time limit and game progress are independent. In this case, the game proceeds and completes regardless of any events or conditions associated with the universal progressive pool.

The present invention also relates to managing a universal progressive pool for different games and gaming machines. Elements of this management include maintaining the award pool, collecting contributions from individual gaming machines and wagers, funds accounting, distributing awards, data management of a dynamic financial system, security and pool integrity, and maintaining a reserve pool used to seed the award pool in the event of a win.

Universal progressive pool management services may be performed and provided by a wide variety of entities. For example, a casino or other gaming establishment may implement a universal progressive pool for different games and gaming machines it controls. Alternatively, a gaming services provider (a separate business entity) may run a universal progressive pool and charge owners of participating gaming machines for the service. This allows multiple casinos and individual gaming establishments (restaurants, gas stations etc.) to participate in a universal progressive pool that extends far beyond their limited number of gaming machines. Many gaming machine manufacturers may also provide universal progressive pool services described herein. In a specific embodiment, participation in a progressive pool offered by a gaming machine manufacturer is limited to gaming machines or games sold by the gaming machine manufacturer to increase sales of machines and games.

In one business model, a gaming machine manufacturer provides universal progressive pool services to one or more entertainment establishments that act as customers. There are many entertainment establishments that may act as customers for the services and benefit from the present invention. Exemplary entertainment establishments include casinos, racetracks, restaurants, hotels, gas stations, truck stops, etc. In a specific embodiment, gaming machines in each participating establishment contribute small amounts of wagers to the universal progressive pool in real time. The services provider then bills each gaming establishment to collect monies for the progressive contributions. The billing may occur at regular intervals. One suitable billing interval is monthly. The services provider then collects money from each establishment and controls distribution of the funds to pool winners.

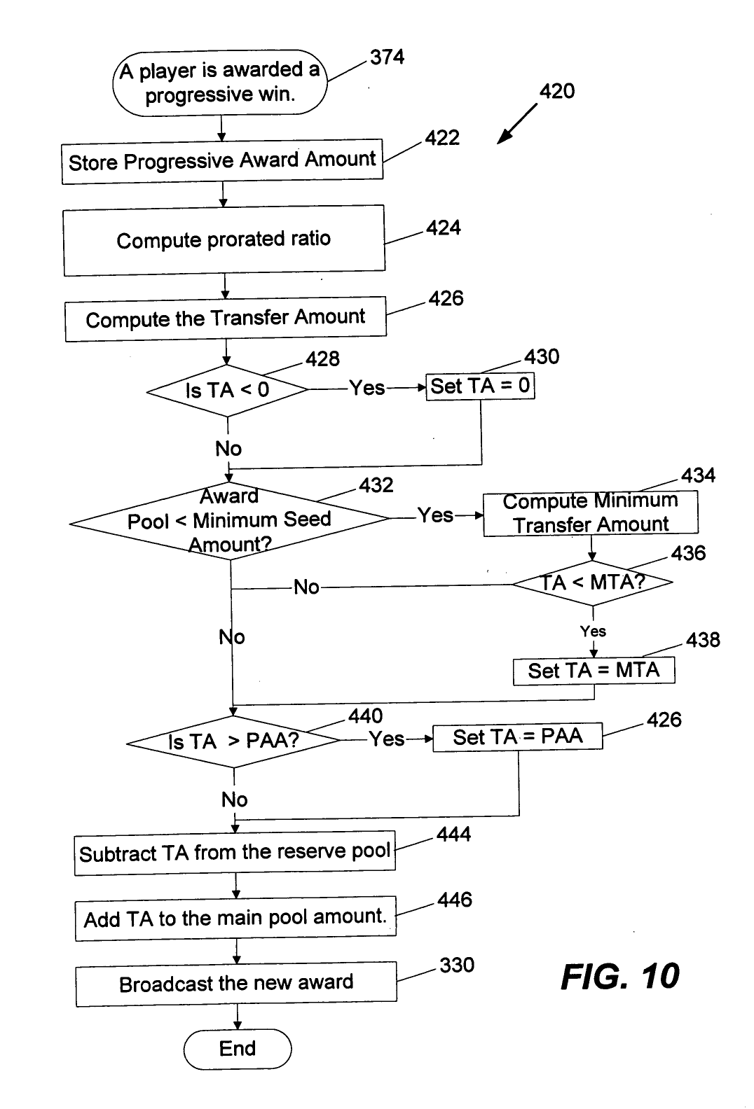

FIG. 10 illustrates a process flow 420 for managing an award pool and a reserve pool in accordance with one embodiment of the present invention. Process flow 420 begins when a player wins or is granted a universal progressive pool award (374). This obligates the progressive pool administrator to allocate funds to the winner and review status of the award pool. In many cases, the award pool may require re-seeding from a reserve pool.

In some cases, a winning outcome distributed to a gaming machine triggers discovery of the winning event and review of funds in the award pool and reserve pool. For example, a pool manager 54 as that described above with respect to system 50 of FIG. 1A that selects outcomes from a pool and sends the winning outcome to the gaming machine may also be configured to send a message to the pool administrator 52 to communicate the winning event and facilitate management of the universal progressive pool. In another embodiment, the gaming machine is configured to select outcomes from a progressive pool and, upon selection a winning outcome, communicate the event to the appropriate party. A digital message across a communication link such as a phone line or Internet link is suitable for communicating the winning event. The message may also include details of the event such as the wager used on the gaming machine and the time of the wager. Thus, the present invention permits management and implementation of a universal progressive pool regardless of where administration occurs or the geographic relationship between the progressive pool administration and a gaming machine or pool manager. Alternatively, a winning event may be triggered to the progressive pool administration after confirmation of a win either at the gaming machine or at the gaming establishment.

The universal progressive pool administrator then stores the winning universal progressive award (422). In one embodiment, a pool award refers to a representation of an amount of money or credit. For example, the pool award may include a digital representation calculated and stored by a computer that receives progressive contributions (or digital messages for progressive contributions) from participating gaming machines in the universal progressive pool. The pool representation may monitor debits and credits for a financial entity such as a bank account that is dedicated to a progressive award pool and a reserve pool. The present invention contemplates other schemes for representing a pool.

It is understood that there may be differences between an actual bank account for the award pool or reserve pool and their respective digital representation. For example, not all monies may have been collected and received by the gaming services provider yet and placed into the represented bank account. In embodiments where progressive contributions are accumulated and updated in real time, it is common for the universal progressive pool award to be larger than funds collected and stored in a bank account or other financial vehicle for holding progressive contributions. Regardless of the representation, process flow 420 sets aside funds for the winning outcome. If a digital representation is employed in real time, storing the winning award may comprise both reducing the digital representation of the pool award and committing the funds from a bank account or other financial vehicle.

Many gaming systems report contributions from each gaming machine for each game play in real time. In this case, a centralized game pool administrator receives updates from all the gaming machines participating in the universal progressive pool, computes the ongoing and growing total universal progressive pool award, and sends the updated amount to each gaming machine or game pool manager. For example, digital communication and dial-up links may be used to periodically update the centralized game pool administrator. The periodic updates may occur at hourly intervals, intervals less than an hour and/or intervals greater than an hour. Some gaming machines report progressive contributions as wagers are made. The amount of money in the universal progressive award pool at the time of receiving the winning outcome is then recorded as the winning progressive award amount.

A prorated ratio for the winning wager is then determined by the game pool administrator (424). This compares a ratio between the current wager made to acquire the winning outcome against a reference wager allowed for the universal progressive pool. The reference wager refers to a wager value for the progressive pool for determining the amount of the pool awarded in for a winning outcome. In some cases, the reference wager is used to normalize all wagers made for the universal progressive pool and normalize all winnings from the pool. In one embodiment, the reference wager equals the maximum wager for the universal progressive pool. Two examples provided above in which the current wager may be less than the maximum permissible wager include when the gaming machine requires a fixed bet that is less than the maximum wager and/or when the gaming machine permits incremental bets and the player selects an incremental wager that is less than the maximum permissible wager.

Process flow 420 then computes a transfer amount (426). The transfer amount refers to an amount of money or credit moved from the reserve pool to the award pool. This may constitute both a transfer between digital representations of the reserve and award pools and a financial transfer for respective bank accounts. The present invention contemplates a variety of methods that may be used in determining how much to transfer from a reserve pool to the award pool in the event of a win in a universal progressive pool. In a specific embodiment, the transfer amount is calculated as the reserve pool amount multiplied by the ratio determined in step 424.

A determination is then made to verify that the transfer amount is positive—or greater than zero (428). In one embodiment, a gaming services provider initiates a universal progressive pool with no money in the award pool and reserve pool. At inception, the award pool may be seeded from the reserve pool and the reserve pool initially accrues a negative balance that corresponds to the size of the seed. As time proceeds, progressive contributions to the reserve pool (328 of FIG. 5) accumulate so that the reserve pool eventually escapes its initial negative balance. After the reserve pool reaches a positive balance, and depending on how funds for the universal progressive pool are managed, a negative balance in the reserve pool may then seldom occur. However, it is contemplated that the reserve pool may operate with a negative balance—either initially or depending on funds management. Process flow 420 thus determines if the transfer amount is negative. If the transfer amount is negative, then process flow 420 sets the transfer amount to zero (430).

If the transfer amount is positive, or after the transfer amount has been set to zero, process flow 420 then determines if the award pool amount is less than the minimum seed for the universal progressive pool (432). As mentioned above, the minimum seed refers to a predetermined minimum amount that is maintained in the award pool to attract game players and casino patrons to gaming machines offering the universal progressive pool. Depending on the size of the prorated ratio, the award pool may or may not need to be seeded. At one extreme, a person wins the entire jackpot and the award pool is reseeded to the predetermined minimum seed. At the other extreme, a person wins a very small portion of the jackpot and the award pool remains well above the minimum seed amount and requires no support from the reserve pool. There are countless possibilities in between the two extremes where the award pool may need to be partially reseeded using the reserve pool.

If, after distribution of the award, the award pool has fewer funds than the minimum seed, then process flow 420 determines a minimum transfer amount to relocate from the reserve pool to the award pool (434). In one embodiment, the minimum transfer amount equals the minimum seed minus the new award pool amount. This ensures that the award pool always maintains the minimum seed. Thus, when the present invention is automated and process flow 420 is implemented via a centralized pool administration computer and software run by the computer, the universal progressive pool and minimum seed amount are guaranteed regardless of time of day. As one of skill in the art will appreciate, casinos rarely close and gaming machine contributions and win outcomes may occur at any time.

Process flow 420 also checks (436) if the transfer amount (as determined in 426) is less than the minimum transfer amount (as determined in 434). If it is less, than the transfer amount is set to the minimum transfer amount (438).

If the transfer amount is greater than the minimum transfer amount, or has been reset to the minimum transfer amount, then process flow 420 also determines if the transfer amount is greater than the winning award (440). If the transfer amount is greater than the winning universal progressive award, then the transfer amount is set to equal the winning universal progressive award (442).

Now that the transfer amount has been finally determined, process flow 420 then proceeds to subtract the transfer amount from the reserve pool (444) and add the transfer amount to the award pool (446). In both cases, this may comprise altering the digital representation of each pool and performing a financial transaction that corresponds to each change.

Process flow 420 then broadcasts the new universal progressive pool award (330). In one embodiment, administration of the universal progressive award occurs in real time and the new award is broadcast in real time to distributed gaming machine displays that inform patrons of changes in real time.

Having discussed exemplary methods of administering and managing a universal progressive game pool and various game pool components, pool construction will now be briefly described.

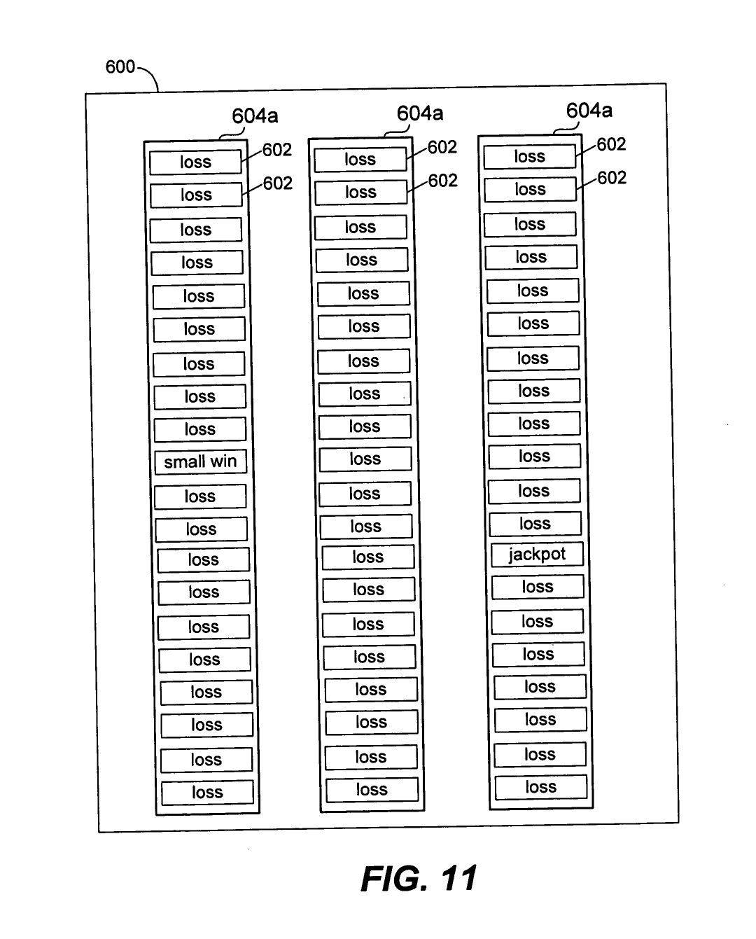

FIG. 11 shows an illustrative pool 600 in accordance with a specific embodiment of the present invention. Pool 600 is intended for use with a universal progressive system that offers awards to gaming machines regardless of the game or wager used to qualify for an outcome of the progressive pool. Pool 600 provides an inventory all available awards and non-award outcomes 602 for a universal progressive pool. Pool 600 may comprise a data structure, such as a database or logical representation of a table, which enumerates and identifies each outcome 602. In this case, pool 600 includes a set of data elements that each corresponds to a particular universal progressive pool outcome 602. The data structure, or a deck portion thereof, may be stored in memory of a game pool administrator processing system, game pool manager processing system, and/or a gaming machine processing system.

Each outcome 602 refers to a result for a universal progressive pool. Exemplary outcome 602 may include a win, loss, small or partial win, complete jackpot or large prize win, awarding of a miscellaneous prize, etc. As the term is used herein, an award generally refers to any incentive granted to a player for playing a game on a gaming machine. Common awards include cash, prizes (free meals, tickets to entertainment events, hotel offers such as rooms, vacations—local and distant, cars, houses, etc.), and game credits.

Each outcome may be stored as an enumerated data structure or entry in a table or database. In one embodiment, each outcome 202 is specified as a random number seed. Further information on random number seated as provided in commonly owned U.S. Pat. No. 6,533,664 entitled “Gaming System with Individualized Centrally Generated Random Number Generator Seeds”, which is incorporated by reference herein in its entirety for all purposes. Other suitable data storage mechanisms may be used to represent and store an outcome 602 and the present invention is not limited to any particular data construct used to represent an outcome 602.

A pool may repeat outcomes. For example, one or more losing outcomes may form a majority of the entries in some pools. Each pool 600 may include any desired number of a particular outcome type. For example, a ‘loss’ outcome may constitute 70% of the outcomes in a pool. The frequency of each outcome 602 may vary. Less frequent outcomes may include jackpot award outcomes and large prizes. The present invention allows a game pool designer to set and control the type of outcomes inserted in a game pool - and the frequency of each outcome.

Pool 600 typically includes a fixed size collection of predetermined outcomes 602. The number of outcomes 602 in pool 600 may vary greatly. For example, ten million outcomes 602 for a pool may suit some universal progressive pools. Greater and fewer outcomes 602 than are ten million in a single pool are possible. In one embodiment, the pool is generated with from about 64,000 outcomes to about 100,000 outcomes. Jurisdictional requirements may also affect pool size and composition. One suitable construction methodology is described in commonly owned pending patent application Ser. No. 10/371,722 and titled “APPARATUS AND METHOD FOR GENERATING A POOL OF SEEDS FOR A CENTRAL DETERMINATION GAMING SYSTEM”. This document is incorporated by reference herein in its entirety for all purposes.

As shown, pool 600 has been divided into multiple decks 604 after random reorder of individual outcomes 602. Three decks 604a-c are shown. The number of outcomes 602 in each deck 604 may vary greatly. For example, ten thousand outcomes 602 for each deck 604 may service a single gaming machine for an extended time. Greater and fewer outcomes 602 than are ten thousand in a single deck 604 are contemplated and may vary based on the size of the pool and the expected usage rate of the receiving entity. Each deck 604 may be distributed as desired. In some cases, a single gaming machine or pool manager stores multiple decks 604 and distributes from the multiple decks. If the outcomes in each deck have already been randomly ordered, selection from the decks may be sequential (or random if the gaming machine is already configured in this manner).

When a pool 600 has been completely expended, all outcomes will have been output to players. This permits the game pool administrator to estimate and calculate cash flow, including income from individual progressive contributions and expenditures associated with prizes, for the entire pool. As mentioned above, the present invention includes a mechanism for reseeding a universal progressive award on the fly. For example, a new universal progressive cash jackpot may be automatically created when the existing progressive jackpot is fully awarded. As a result, a winning outcome or record for universal progressive pool 600 need not be the last record in the pool. This permits multiple pools 600 to be run simultaneously for a single universal progressive system. In other words, the game pool administrator may run ten pools 600 knowing that when all ten have been completed, overall cash flow for all ten will be accounted for. Universal progressive systems that run a single pool 600 are also possible. One of skill in the art will appreciate that any number of pools 600 may be established for a universal progressive pool.

The present invention may employ a wide variety of gaming machines. Returning back to FIGS. 2A and 2B, an exemplary gaming machine 10 for use according to one embodiment of the present invention is illustrated in perspective view.

Gaming machine 10 includes a top box 11 and a main cabinet 12, which generally surrounds the machine interior and is viewable by users. Main cabinet 12 includes a main door 20 on the front of the machine, which opens to provide access to the interior of the machine. Attached to the main door are typically one or more player-input switches or buttons 21; one or more money or credit acceptors, such as a coin acceptor 22, and a bill or ticket scanner 23; a coin tray 24; and a belly glass 25. Viewable through main door 20 is a primary video display monitor 26 and one or more information panels 27. The primary video display monitor 26 may include a cathode ray tube, flat-panel LCD, plasma/LED display or other conventional electronically controlled video display. Top box 11, which typically rests atop of the main cabinet 12, may also contain a ticket printer 28, a key pad 29, one or more additional displays 30, a card reader 31, one or more speakers 32, a top glass 33, one or more cameras 34, and one or more secondary video display monitors 35, which may also be a cathode ray tube, high resolution flat-panel LCD, plasma/LED display or other conventional electronically controlled video monitors. Other components and combinations are also possible, as is the ability of the top box to contain one or more items traditionally reserved for main cabinet locations, and vice versa.

It will be readily understood that gaming machine 10 can be adapted for presenting and playing any of a number of games and gaming events, particularly games of chance involving a player wager and potential monetary payout, such as, for example, a wager on a sporting event or general play as a slot machine game, a keno game, a video poker game, a video blackjack game, and/or any other video table game, among others. While gaming machine 10 is usually adapted for live game play with a physically present player, it is also contemplated that such a gaming machine may also be adapted for remote game play with a player at a remote gaming terminal. Such an adaptation preferably involves communication from the gaming machine to at least one outside location, such as a remote gaming terminal itself, as well as the incorporation of a gaming network that is capable of supporting a system of remote gaming with multiple gaming machines and/or multiple remote gaming terminals.

Gaming machine 10 may also be a “dummy” machine, kiosk or gaming terminal, in that all processing may be done at a remote server, with only the external housing, displays, and pertinent inputs and outputs being available to a player. Further, it is also worth noting that the term “gaming machine” may also refer to a wide variety of gaming devices in addition to traditional free standing gaming machines such as that shown in FIGS. 2A-2B. Such other gaming machines can include kiosks, set-top boxes for use with televisions in hotel rooms and elsewhere, and many server based systems that permit players to log in and play remotely, such as at a personal computer or PDA. All such gaming devices can be considered “gaming machines” for purposes of the present invention and following discussion, with all of the disclosed metering techniques and devices being adaptable for such uses of alternative gaming machines and devices.

With reference to FIG. 2B, the gaming machine of FIG. 2A is illustrated in perspective view with its main door opened. In additional to the various exterior items described above, such as top box 11, main cabinet 12 and primary video display monitor 26, gaming machine 10 also comprises a variety of internal components. As will be readily understood by those skilled in the art, gaming machine 10 contains a variety of locks and mechanisms, such as main door lock 36 and latch 37. Other locks 38, 39 on various other machine components can also be seen. Internal portions of coin acceptor 22 and bill or ticket scanner 23 can also be seen, along with the physical meters associated with these peripheral devices. Processing system 50 includes computer architecture for participating in a universal progressive pool regardless of the game or wager used on gaming machine 10, and will be described below with respect to FIG. 12.

When a person wishes to play a gaming machine 10, he or she provides coins, cash or a credit device to a scanner included in the gaming machine. The scanner may comprise a bill scanner or a similar device configured to read printed information on a credit device such as a paper ticket or magnetic scanner that reads information from a plastic card. The credit device may be stored in the interior of the gaming machine. During interaction with the gaming machine, the person views game information using a video display. Usually, during the course of a game, a player is required to make a number of decisions that affect the outcome of the game. The player makes these choices using a set of player-input switches.

After the player has completed interaction with the gaming machine, the player may receive a portable credit device from the machine that includes any credit resulting from interaction with the gaming machine. By way of example, the portable credit device may be a ticket having a dollar value produced by a printer within the gaming machine or a ticket that includes indication of a universal progressive pool win. A record of the credit value of the device will be stored in a memory device provided on the network 100 (e.g., a memory device associated with CVT 106 and/or processing system 101). Any credit on some devices may be used for further games on other gaming machines 10. Alternatively, the player may redeem the device at a designated change booth or pay machine.

The present invention employs one or more processing systems. For example, a processing system in a gaming machine or universal pool manager may be configured to a) request universal progressive pool decks from a pool administrator, b) select outcomes from a universal progressive pool deck, c) select outcomes from a game pool deck for a game run on the computer, d) interface with a player, and e) communicate and interface with a gaming system or network. A processing system in a universal pool administrator may be configured to a) create a universal progressive pool, b) divide the pool into decks, c) distribute the decks, c) collect progressive contributions from participating gaming machines, d) manage an award pool and reserve pool, and e) communicate with numerous gaming machines using a variety of communications protocols.

Referring now to FIG. 12, a simplified processing system 500 is shown in accordance with one embodiment of the present invention. In one embodiment, processing system 500 is included in a gaming machine. In another embodiment, the gaming machine operates in a network and processing system 500 is included in a computer or central controller that operates on the network, such as game pool manager 54 as described above. For the network 100 of FIG. 1B, processing system 500 may be included in information services 108 or in a Clerk Validation Terminal (CVT) 106. In this case, the gaming machine communicates with processing system 500 across network 100 according to its location in the network.

Processing system 500 comprises a processor (or CPU) 502, interfaces 504, memory 506, and a bus 508 (e.g., a PCI bus). When acting under the control of appropriate software or firmware, processor 502 implements universal game pool functions as described herein. CPU 502 may include one or more processors such as a processor from the Motorola family of microprocessors or the MIPS family of microprocessors. In an alternative embodiment, processor 502 is specially designed hardware for controlling the operations of a gaming machine. In one embodiment, a memory 510 (such as non-volatile RAM and/or ROM) also forms part of CPU 502. However, there are many different ways in which memory could be coupled to the processing system.

Interfaces 504 control the sending and receiving of data over a network in communication with system 500 and may support other peripherals used with system 500. Among the interfaces that may be provided are Ethernet interfaces, cable interfaces, wireless interfaces, dial up interfaces, and the like. In addition, various very high-speed interfaces may be provided such as fast Ethernet interfaces, ATM interfaces and the like.

Although the system shown in FIG. 12 is one specific processing system, it is by no means the only processing system architecture on which the present invention can be implemented. Regardless of the processing system configuration, it may employ one or more memories or memory modules (e.g., memory 506) configured to store program instructions for gaming machine network operations and operations associated with universal progressive pools described herein. Such memory or memories may also be configured to store player interactions, data structures such as outcomes and progressive pool decks and pools described above, instructions for communicating with other elements in a universal progressive pool environment such as the pool administrator and managers, instructions for one or more games played on the gaming machine, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the foregoing invention has been described in some detail for purposes of clarity of understanding, it will be apparent that certain changes and modifications may be practiced within the scope of the appended claims. Therefore, the present examples are to be considered as illustrative and not restrictive, and the invention is not to be limited to the details given herein, but may be modified within the scope of the appended claims.

What is claimed is:

1. A gaming system that provides a progressive pool to gaming machines, the gaming system comprising:
a first gaming machine that permits play of a first game type;
a second gaming machine that permits play of a second game type that is different from the first game type; and
a progressive pool administrator configured to a) manage a progressive pool award that is winnable at the first gaming machine and the second gaming machine and b) receive a first progressive contribution generated at the first gaming machine and add at least a portion of the first progressive contribution to the progressive pool award and receive a second progressive contribution generated at the second gaming machine and add at least a portion of the second progressive contribution to the progressive pool award.

2. The system of claim 1 wherein the progressive pool administrator is configured to create the progressive pool and the progressive pool comprises a set of outcomes for the progressive award.

3. The system of claim 1 wherein the progressive pool administrator is configured to distribute outcomes for the progressive pool.

4. The system of claim 3 wherein the progressive pool administrator distributes a portion of the progressive pool to the first gaming machine.

5. The system of claim 3 further comprising a progressive pool manager that receives a portion of the progressive pool form the progressive pool administrator.

6. The system of claim 5 wherein the progressive pool comprises a set of outcomes for the progressive award and the progressive pool manager sends an outcome for the progressive pool to the first gaming machine.

7. The system of claim 1 wherein the first progressive pool contribution comprises an electronic message that includes information related to a wager made at the first gaming machine.

8. The system of claim 1 wherein the first gaming machine and the second gaming machine share a) a common manufacturer, b) are located in the same gaming establishment, or c) are included in the same geographic region.

9. A gaming system that provides a progressive pool to gaming machines, the gaming system comprising:
a progressive pool administrator configured to a) create a progressive pool that includes a set of outcomes for a progressive award and b) distribute the outcomes; and
a progressive pool manager configured to a) receive a subset of outcomes from the progressive pool administrator, and b) send a first outcome of the progressive pool to a first gaming machine that permits play of a first game type and send a second outcome of the progressive pool to a second gaming machine that permits play of a second game type that is different from the first game type.

10. The system of claim 9 wherein the progressive pool administrator distributes the outcomes by sending multiple decks to the progressive pool manager, wherein each deck comprises a subset of outcomes.

11. The system of claim 9 further comprising a third gaming machine that receives outcomes from the progressive pool administrator.

12. The system of claim 1 1 wherein the third gaming machine runs a third game type.

13. The system of claim 9 wherein the progressive pool administrator is configured to distribute the outcomes to the progressive pool manager in response to a request from the progressive pool manager.

14. The system of claim 9 wherein the first gaming machine and the second gaming machine permit different wager amounts.

15. The system of claim 9 wherein the progressive pool manager sends an outcome for the progressive pool to the first gaming machine in response to a communication from the first gaming machine that a player has provided a wager at the first gaming machine.

16. The system of claim 9 wherein an outcome for the progressive pool is independent from an outcome for a game at the first gaming machine.

17. The system of claim 9 wherein the first gaming machine and the second gaming machine: a) share a common manufacturer, b) are located in the same gaming establishment, or c) are included in the same geographic region.

18. A gaming machine that participates in a progressive pool, the gaming machine comprising:
an external cabinet defining an interior region of the gaming machine, the external cabinet adapted to house a plurality of gaming machine components within or about the interior region;
a display device adapted to display game play information, the display device being located within or about the external cabinet;
a scanner configured to receive credit from a player that is used as a wager to initiate a game on the gaming machine;
a processing system configured to output an outcome of the progressive pool to the player,
wherein participation in the progressive pool by the gaming machine is independent of a game type for the game played on the gaming machine; and
a network interface that allows the gaming machine to receive the outcome.

19. The gaming machine of claim 18 wherein the progressive pool award is altered in size relative to an amount of the wager.

20. The gaming machine of claim 18 wherein the network interface is configured to communicate with a game pool manager that provides the outcome to the gaming machine and at least one other gaming machine.

21. The gaming machine of claim 20 wherein the game pool manager is included in a cluster controller.

22. The gaming machine of claim 20 wherein the game pool manager and the gaming machine are located in the same gaming establishment.

23. The gaming machine of claim 20 wherein the game pool manager provides a deck of outcomes to the gaming machine.

24. The gaming machine of claim 18 wherein the network interface is configured to communicate with a game pool administrator that created the progressive pool.

25. The system of claim 1 wherein an outcome for the progressive pool is independent of an outcome for a game played on the gaming machine.

26. A game pool manager that provides progressive pool outcomes for a progressive award to multiple gaming machines, the game pool manager comprising:
a processing system configured to a) receive a set of outcomes for a progressive pool, and b) select a first outcome of the progressive pool from the set of progressive pool outcomes for distribution to a first gaming machine that permits play of a first game type and select a second outcome of the progressive pool from the set of progressive pool outcomes for distribution to a second gaming machine that permits play of a second game type that is different from the first game type; and
a network interface that permits the game pool manager to send the first outcome to the first gaming machine and to send the second outcome to the second gaming machine.

27. The game pool manager of claim 26 wherein the progressive pool manager sends the first outcome to the first gaming machine in a deck of outcomes.

28. The game pool manager of claim 26 wherein the progressive pool manager is configured to receive a progressive contribution generated at the first gaming machine and send the progressive contribution to a progressive pool administrator.

29. The game pool manager of claim 28 wherein the progressive pool manager is configured to receive a second progressive contribution generated at the second gaming machine and send the second progressive contribution to the progressive pool administrator.

30. The game pool manager of claim 28 wherein the progressive pool manager is configured to receive the set of progressive pool outcomes from the progressive pool administrator.

31. The game pool manager of claim 26 wherein the first progressive pool contribution includes an electronic message of a wager made at the first gaming machine.

32. The system of claim 26 wherein the first gaming machine and the second gaming machine: a) share a common manufacturer, b) are located in the same gaming establishment, or c) are included in the same geographic region.

33. A method for building a progressive award, the method comprising:
adding at least a portion of a first progressive contribution to a progressive award pool, wherein the first progressive contribution is generated at a first gaming machine that permits play of a first game type; and
adding at least a portion of a second progressive contribution to the progressive award pool, wherein the second progressive contribution is generated at a second gaming machine that permits play of a second game type.

34. The method of claim 33 wherein the first progressive contribution and the second progressive contribution are about equal.

35. The method of claim 33 wherein the first gaming machine permits a larger wager than the second gaming machine.

36. The method of claim 33 wherein the first gaming machine permits incremental wagers.

37. The method of claim 33 wherein the progressive contribution includes a percentage of a wager made at the first gaming machine.

38. The method of claim 33 wherein the entire progressive contribution is added to the progressive award pool.

39. The method of claim 33 wherein the progressive award pool permits a maximum wager across all gaming machines participating that offer the progressive award.

40. The method of claim 33 further comprising adding a portion of the progressive contribution not added to the progressive award pool to a reserve award pool used to seed the progressive award pool.

41. The method of claim 33 further comprising broadcasting a new progressive award after adding the portion of the first progressive contribution to the progressive award pool.

42. The method of claim 33 awarding a fraction of the progressive award to a player at the first gaming machine based on a wager input by the player for the game.

43. The method of claim 42 further comprising determining a ratio used in awarding the progressive award based on the wager input by the player relative to a reference wager for the progressive award pool.
